(19) United States
(12) Patent Application Publication
(10) Pub. No.: US 2022/0347572 A1
(43) Pub. Date: Nov. 3, 2022

(54) METHOD AND APPARATUS FOR FACILITATING A SEQUENCE OF EVENTS ALONG RAILS OF A BATTLE FIELD VIA A COMPUTER SIMULATION

(71) Applicant: MEDIA ALLIANCE GAMING STUDIO, INC., San Jose, CA (US)

(72) Inventor: Hannah Grace Larson, Elbe, WA (US)

(21) Appl. No.: 17/246,567

(22) Filed: Apr. 30, 2021

(51) Int. Cl. A63F 13/52; A63F 13/822

(52) U.S. Cl. CPC A63F 13/52; A63F 13/822

(57) ABSTRACT

A video gaming system and/or interactive gaming process uses a resource confined simulation (“RCS”) system to emulate battles based on at least in part on historical events. One embodiment of video game system provides a film mode which initiates a sequence of events emulating a series of combat events based on at least a portion of historical events. In addition, the video game provides a method of timeline or geographic normalization in multiverse events during a video game for synchronizing time discrepancies between various nodes in the theater of battle fields.

### FIELD

The exemplary embodiment(s) of the present invention relates to the field of computer hardware and software. More specifically, the exemplary embodiment(s) of the present invention relates to computer simulation or video games.

### BACKGROUND

Video games and/or interactive real-time computing-based games are generally played on various types of electronic systems. For example, systems can be connected by a network such as Internet for real-time interactive playing. Typical electronic systems which can host video games or interactive games include laptop computers, smartphones, tablets, desktop computers, handheld portable devices, and/or video game consoles, such as PlayStation 4, Xbox One, and/or Nintendo Switch. The hardware and/or software capable of hosting conventional video games is typically relating to fictitious stories with unlimited resources.

A drawback associated with a conventional video game operated by a typical electronic system is that it generally lacks values such as historical, educational, and/or teaching values.

### SUMMARY

An electronic video game emulated by a resource confined simulation (“RCS”) system based on in part historically occurred battles is disclosed. The RCS system, in one embodiment, provides a film mode which can be activated to play a sequence of events emulating a series of war events, including combat, based on at least some historical events. Upon simulating a rail or rails containing multiple conflicting nodes emulating a war theater in accordance with recorded historical facts, a user or game player begins to travel on a rail containing various nodes. After receiving an inquiry of film mode by a player or user, the process retrieves the film data which represents the historical battles corresponding to various conflicting nodes on the rail or rails. The film mode facilitates playing the film(s), movies, and/or videos reflecting the historical battles corresponding to at least some of the conflict nodes on the rail in which the player is currently traveling on.

In an alternative embodiment, the RCS system provides a process of timeline normalization in multiverse events during a video game to reduce timeline discrepancies between various players at the nodes of battle fields in the war theatre. Upon initiating a video game, the RCS system emulates a war theater containing rails with various alternative nodes in accordance with recorded historical facts and/or alternative possible rail paths. Upon identifying the number of players of the video game who are traveling between the nodes on the rails, various time stamps associated with nodes indicating arrival times of the players are monitored and recorded. After identifying an optimal time for timeline normalization in response to the recorded time stamps for all of the players, a process of normalizing timeline is performed to re-synchronize the timeline at all of the nodes.

Additional features and benefits of the exemplary embodiment(s) of the present invention will become apparent from the detailed description, figures and claims set forth below.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a resource confined simulation (“RCS”) system for emulating a sequence of events in accordance with at least in part on the historical events in accordance with one or more embodiments of the present invention;

FIG. 2 is a block diagram illustrating a detailed database builder and database in accordance with one or more embodiments of the present invention;

FIG. 3 is a logic block diagram illustrating an exemplary process of emulating RCS in accordance with established parameters in accordance with one or more embodiments of the present invention;

FIG. 4 is a logic block diagram illustrating an alternative logic flow for emulating RCS in accordance with one or more embodiments of the present invention;

FIG. 5 is an event tree diagram illustrating an exemplary rail tree containing multiple rails for emulating RCS in accordance with one or more embodiments of the present invention;

FIG. 6 is a block diagram illustrating a rail tree containing multiple rails and nodes in a theater emulated via RCS in accordance with one or more embodiments of the present invention;

FIG. 7 is a logic block diagram illustrating a process of moving or progressing a player between nodes on a rail emulating by RCS in accordance with one or more embodiments of the present invention;

FIG. 8 is a block diagram illustrating an exemplary logic process progressing between nodes on one or more rails via RCS in accordance with one or more embodiments of the present invention;

FIG. 9 is a flowchart illustrating an exemplary process of RCS emulating a player's progress or movement between nodes on a rail in accordance with one embodiment of the present invention;

FIG. 10 is a flowchart illustrating an exemplary process of RCS emulating symbols superimposed over a map showing movements between nodes on a rail in accordance with one embodiment of the present invention;

FIGS. 11A-11C are maps containing geographic terrains illustrating a battle field using symbols superimposed over the map showing a node on a rail in accordance with one embodiment of the present invention;

FIG. 12 is a block diagram illustrating a video game hosted or facilitated by an RCS system containing a film mode capable of playing a film showing a historical battle in accordance with one or more embodiments of the present invention;

FIG. 13 is a flowchart illustrating an exemplary process of RCS having a film mode capable of playing a sequence of historical events in accordance with one embodiment of the present invention;

FIG. 14A is a block diagram illustrating a process of timeline normalization simulated by RCS system for emulating one or more rails in a war theater in accordance with one or more embodiments of the present invention;

FIG. 14B is a block diagram illustrating an exemplary battle field scenario with phases or stages of timeline in accordance with one or more embodiments of the present invention;

FIG. 15 is a flowchart illustrating an exemplary process of timeline normalization simulated by the RCS system capable of emulating a player's progress or movement between nodes on rails in accordance with one embodiment of the present invention;

FIG. 16 is a block diagram illustrating a process of geographic normalization simulated by RCS for emulating one or more rails in a theater in accordance with one or more embodiments of the present invention;

FIG. 17 is a flowchart illustrating an exemplary process of geographic normalization simulated by RCS capable of emulating players' progress or movement between nodes on rails in accordance with one embodiment of the present invention; and

FIG. 18 is a block diagram illustrating a digital processing system capable of being configured to be the RCS system, database builder, and/or simulation allocator in accordance with one or more embodiments of the present invention.

### DETAILED DESCRIPTION

Embodiments of the present invention are described herein with context of a method and/or apparatus for facilitating resource confined simulation (“RCS”) such as computer games, video games, and/or educational program based on certain historical background and/or events.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

A process or RCS system capable of emulating RCS also be referred to as a video game(s) or computer game(s) is presented. The RCS system can be a user interactive simulation-based system using at least a portion of historical event via a communications network. The RCS system, which includes a digital processor, memory, and network communication transceiver, is able to establish a historical based information system for emulating RCS. After identifying a historical event in accordance with recorded historical facts for creating an environment to simulate an RCS, the RCS system generates a map as a geographic parameter associated with the RCS in accordance with historical geography relating to the historical event. Upon generating armed force as a military parameter associated with the RCS in accordance with the historical event, a map storage is used to store the map related parameters and an armed force storage for storing the armed force related parameters. The RCS system is able to emulate the RCS in response to various parameters such as the map, armed force, and/or the user input.

The presently claimed embodiment discloses an electronic video game system using RCS to simulate historical battle fields according to in part various historical facts. The system simulates rails containing multiple conflicting nodes or events during a historical theater. A rail containing multiple nodes is a simulation process facilitating a player to walk (or fight) through a sequence of battles based on in part historical events. A sequence of battles is emulated via a rail with multiple nodes wherein the nodes represent battles. A node on a rail represents one or more conflicting events based on the historical facts. After facilitating a user or player traveling on a rail approaching to a node, the system obtains a set of variables having corresponding values in a variable backpack which is designated to the user or player. Upon activating a computational module for calculating updated or modified values of variables, a set of rules designated to the upcoming node is fetched from a rule database. The player or user is then offered an opportunity to change or reenforce the player's fighting capabilities based on the movement of other players' forces and their resources.

One embodiment of video game system provides a film mode which initiates a sequence of events emulating a series of combat events based on at least a portion of historical events. The RCS system, in one embodiment, provides a film mode which can be activated to play a sequence of events emulating a series of combats based on at least a portion of historical events. Upon simulating a rail or rails containing multiple conflicting nodes emulating a theater in accordance with recorded historical facts, a user or game player begins to travel on a rail containing conflicting nodes. After receiving an inquiry of film mode by a player or user, the process retrieves the film data which represents the historical battles corresponding to various conflicting nodes on the rail or rails. The film mode facilitates playing the film(s), movies, and/or videos reflecting the historical battles corresponding to at least some of the conflict nodes on the rail in which the player is currently traveling on.

It should be noted that a player's resource includes armed force, morals, national opinions, international supports, and supplies. In one embodiment, the player's or user's resource is at least in part represented by values of variables assigned to the player. The system, in one example, offers the player or user to use his or her resources to rearrange or reenforce player's military strength in view of other players' movements as well as opposing players' fighting capabilities. Upon user or player's selection, node status containing a set of symbols illustrating enemy forces is presented by superimposed the symbols over the map. After displaying various fighting forces on the map, the system generates a score or outcome evaluating the player's or user's real-time decision-making process and/or capabilities.

Resource Confine Simulation (“RCS”) System

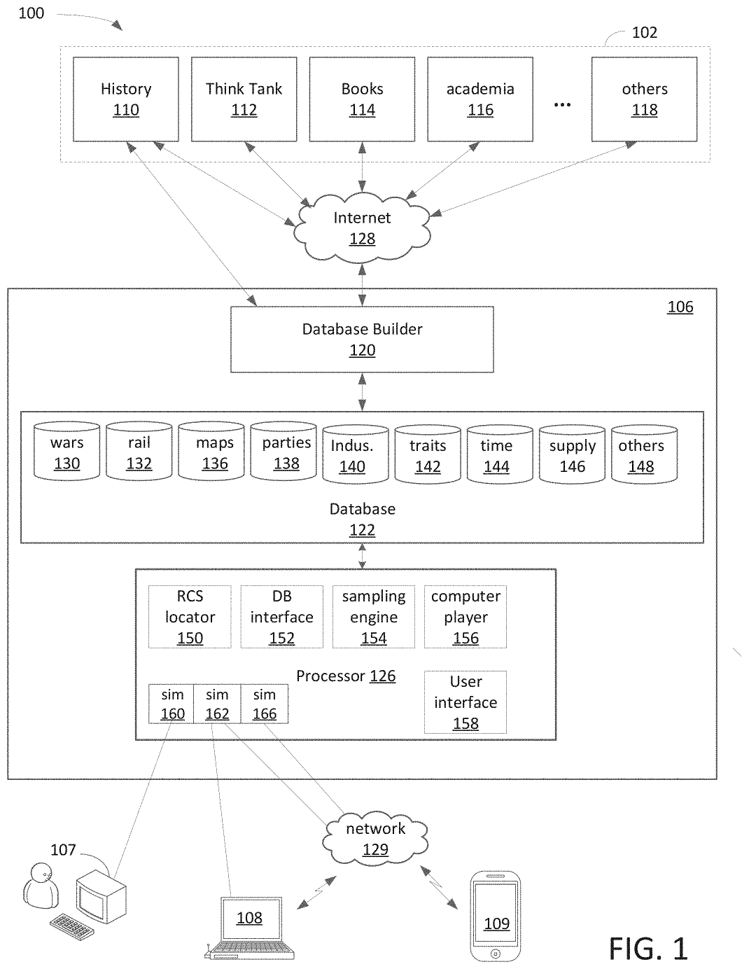

FIG. 1 is a block diagram 100 illustrating an RCS system capable of emulating a sequence of events in accordance with at least in part on the historical events in accordance with one or more embodiments of the present invention. Diagram 100 includes input data 102, RCS system 106, and users 107-109. In one aspect, diagram 100 also includes communications networks 128-129 used for coupling input data 102, RCS system 106, and users 107-109. It should be noted that the underlying concept of the exemplary embodiment(s) of the present invention would not change if one or more blocks (or networks) were added to or removed from diagram 100.

Input data 102, in one embodiment, provides data or information for building a database such as database 122 which will be used to emulate RCS. Input data 102, in one aspect, includes historical data 110, data from think tank 112, recordings from books 114, information from academia 116, and others 118 wherein historical data 110, for example, records or recounts various historical facts and/or events. Such historical data 110 can be generated by historians, museum records, scholars' papers, peoples' recollections from both sides, and the like. In one aspect, historical data 110 is used to emulate an actual historical event(s) during RCS.

Information and/or data from thank tank or foundations 112 can also be part of input data 102 for establishing the database such database 122 for simulation. For example, think tank 112 such as Hoover Institution or Brookings Institution generates think-tank data including, but not limited to, various opinions, geopolitics, and/or predications based on the historical and/or geopolitical data at the time of the event. It should be noted that the think-tank data can also be used to project or predict alternative outcomes instead of actual historical outcomes during hosting of RCS.

Book information 114 includes data from memoirs, documentary movies, articles, and/or books. For example, book information 114 can include recounting of historical events, hypothetical results, or predications of alternative outcomes. In one aspect, book information 114 can be used for both actual historical simulation and alternative simulation for RCS.

Academia studies or papers 116, such as university thesis, essay, dissertation, and/or treatise, can also be used as input data 102. For example, academia papers 116 can be used to refine historical facts, hypothetical alternative outcomes, or missing facts. In one aspect, academia papers 116 can be used for both actual historical simulation and alternative possible outcomes. It should be noted that other information or data such as race, culture, tradition, public sentiment, and/or resolutions from the United Nations, can also be used as input data 102 for emulating RCS.

RCS system 106, in one embodiment, includes a database builder 120, database 122, and processor 126. Database 120 is configured to establish database 122 based on input information 102 for facilitating RCS. Processor 126 is used to facilitate RCS based on parameters stored in database 122 as well as the user inputs. While database builder 120 is responsible to build database 122 from input data 102 via a communications network such as Internet 128, processor 126 employs multiple simulators 160-166 used for interfacing with users 107-109.

Database builder 120, in one embodiment, employs a preloading method, dynamic loading method, or a combination of preloading and dynamic loading method. The preloading method, for example, is a process of building database 122 before an RCS can be simulated. After building of database 122, a user such as user 107 can activate the RCS for simulation. It should be noted that the building process can be automatic based on RCS and the data stored in database 122 using various processes, such as artificial intelligence (“AI”), machine learning (“ML”), manual input, and/or a combination of AI, ML, and manual input.

Alternatively, the dynamic loading, also known as on-demand data building, is a method which is used by database builder 120 or establish necessary data or parameters from a cloud-based RCS network in real-time. For example, upon recognizing that the selected RCS contains no or insufficient data or parameters, database builder 120 is able to search and download necessary information or data to start the selected RCS. Depending on the user input(s), database builder 120 can dynamically build necessary database or parameter to facilitate the selected RCS.

The method of both preloading and dynamic loading can be implemented for certain RCSs. A benefit of using dynamic loading or the combination of preloading and dynamic loading is to save storage space and update the latest information while emulating RCS.

Database 122, in one embodiment, stores various types of data and/or parameters, such as, but not limited to, wars 130, rails 132, maps 136, parties or countries 138, industrial capacity 140, culture traits 142, time duration 144, supply/transportation capabilities 146, and/or others 148. Database 122 can be divided or organized into multiple sub-storage sections such as tables or blocks for storing data 130-148. Depending on the applications and/or RCSs, database 122 can store additional information, such as total population, public sentiment/opinions, world sentiment/opinions, armed force, international supports, and the like. In one example, database 122 can be further organized to store detailed information, such as battalions of armed force, number of warships, number of warplanes, number of tanks, artillery pieces, missiles, chemical weapons, and the like. A function of database 122 is to provide data or information as parameters to processor 126 for facilitating outcome calculation(s).

Processor 126 includes an RCS locator 150, database interface 152, sampling engine(s) 154, computer player 156, user interface 158, and user simulators 160-166. It should be noted that it does not change the scope of processor 126 if additional circuitry or blocks are added or removed. While DB interface 152 is used to communicate with database 122, user interface 158 is used to communicate with users 107-109 via user simulators 160-166. A function of processor 126 is to emulate RCS which can also be referred to as video game(s) and/or interactive war education(s) to produce intermediary or final outcome(s). To simplify forgoing discussion, the term “RCS” will be used in place of video games and/or interactive war educations.

RCS locator 150, in one embodiment, is used to identify one of many simulations or games to play based on the user input. For example, a user such as user 107 can enter a selection of an RCS to play via user simulator 160. Based on user's selection, RCS locator 150 searches through database 122 to locate or identify whether such game or RCS is in the database. Upon allocating the RCS, RCS locator 150, in one aspect, informs processor 126 that the RCS is identified and located. Before activating the selected RCS or game, processor 126 initializes various storage locations and/or tables to load necessary parameters from database 122 for starting to emulate RCS. For example, upon detecting a user input of user 107 selecting RCS of 1973 Middle-East war, RCS locator 150 searches database 122 to identify any data related to 1973 Middle-East war, Yom Kippur War, Ramadan War, October War or the 1973 Arab-Israeli War. Upon verifying that the data is available for selected RCS, processor 126 begins to emulate Yom Kippur War based on the identified data.

Sampling engine 154, in one embodiment, is an RCS engine using one or more statistic algorithms such as Monte Carlo's methods to calculate a battle result or outcome. For example, sampling engine 154 is capable of calculating one or more outcomes based on parameters loaded from database 122. A function of sampling engine 154 is to calculate or project an outcome based on user input(s) as well as various parameters, such as strength of armed force, warplanes, warships, missiles, tanks, supply lines, and the like. Note that Monte Carlo's method is an algorithm using repeated random sampling to obtain numerical results in light of optimization, numerical integration, and probability distribution.

User interface 158 facilitates communication between user simulators 160-166 with processor 126. User simulators 160-166 are used to communicate with users via direct connection such as between user 107 and user simulator 160. Also, user simulators can communicate with users 108-109 via network 129. Depending on the applications, user simulator 162 can connect to user directly or indirectly via a network 129. A function of user simulators such as simulator 160 is to provide an interface between RCS system 106 and users 107-109.

Users 107-109, in one example, can be persons, players, machines, servers, institutions, military trainees, law enforcement trainees, and the like. In one aspect, user such as user 107 is required to enter selections to progress the selected RCS. User can either play RCS with another user or with computer player 156. Note that two remotely situated users can play with each other via a communications network such as network 129.

In one embodiment, RCS system 106 includes user controllers such as user simulators 160-166, a map database such as maps 136, an armed force database such as parties 138, and a digital processor such as processor 126 for facilitating RCS based on at least a portion of the historical events. The user controllers, for example, is able to receive user inputs via one or more user connected consoles for simulating RCS. While the map database stores a map representing a geography associated with the RCS in accordance with historical geography relating to an actual event, the armed force database stores the armed force as a military parameter associated with the RCS in accordance with the historical data. The digital processor generates numerical results or outcomes based on repeated random sampling. Note that the digital processor such as RCS system 106 is able to emulate RCS utilizing numerical or intermediary results in response to the map, armed force, and user input. In one aspect, database 122 includes a party database configured to store data relating to a party involved in the historical event. In one example, RCS system 106 provides a culture characteristic database configured to store data relating to a culture trait based on the historical event. To emulate the RCS, a rail database stores a set of logic flow sequences wherein one of the sequences represents a historic rail and another portion of the sequences may represent another optional rail. A rail includes a set of multiple sequential blocks or events wherein the events are happened in a sequential order according to a time domain. A database controller such as database builder 120 is able to obtain and establish a set of data streams based on at least a portion of the historical events for facilitating RCS.

An advantage of employing RCS system is that it can provide educational teaching as well as entertainment. In addition, RCS system can also predict alternative likely outcomes had certain facts altered.

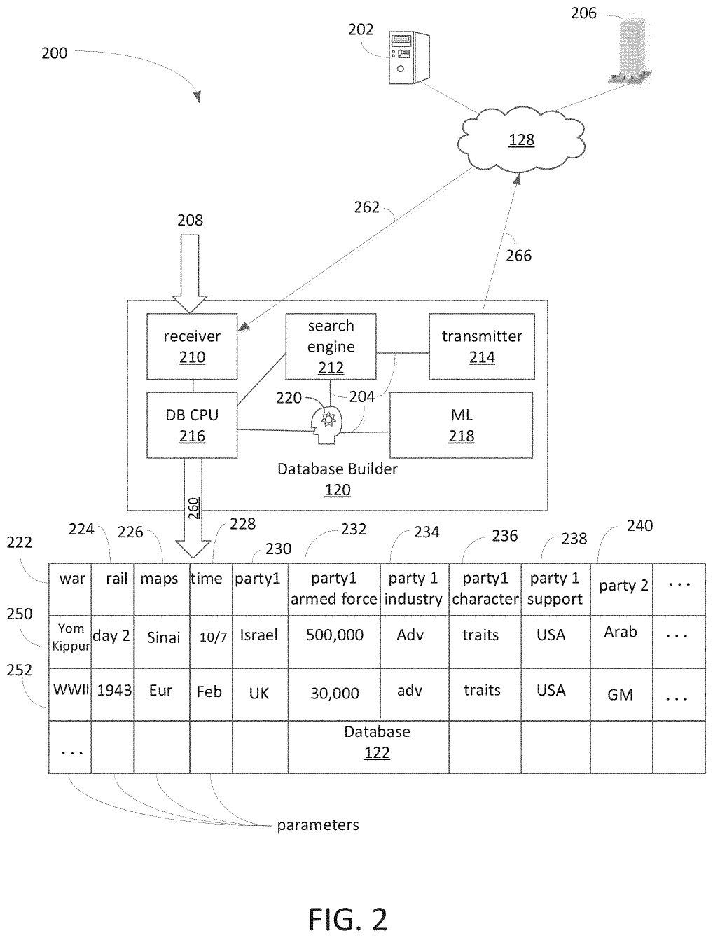

FIG. 2 is a block diagram 200 illustrating a detailed database builder 120 and database 122 in accordance with one or more embodiments of the present invention. Diagram 200 includes database builder 120, database 122, remote server 202, remote content provider 206, and Internet 128. Database builder 120 further includes a receiver 210, search engine 212, transmitter 214, AI component 220, ML component 218, and DB CPU 216. It should be noted that the underlying concept of the exemplary embodiment(s) of the present invention would not change if one or more blocks (or networks) were added to or removed from diagram 200.

A function of database builder 120 is to build a database 122 to support emulation of RCS. Builder 120, in one embodiment, employs a preloading method in which receiver 210 obtains data and/or information either from a manual input 208 or network input via Internet 128 as indicated by numeral 262. The preloading method facilitates establishing database 122 before RCS can be emulated. Depending on the applications, DB CPU (central processing unit) 216 builds database 122 via internal bus 260 in accordance with data from receiver 210. To build database 122, the preloading method can also use AI 220 which manages search engine 212 and transmitter 214 via internal connections 204 to search and obtain relevant information from server 202 and/or content provider 206 via Internet 128. ML 218 is subsequently activated to learn and refine searching capabilities based on obtained data in light of RCS. For instance, the preloading method can use both manual input 208 and IA input to build and verify information stored in data base 122.

Database builder 120 can also be configured to perform a method of dynamic loading, also known as on-demand data building, wherein database 122 stores basic data, parameters, or tables when an RCS begins. DB CPU 216 activates AI 220 to obtain necessary data or parameters from a cloud-based RCS network in real-time wherein the necessary data or parameters contain sufficient information for the current and the next turn or move of RCS based on user input. For example, upon recognizing that the selected RCS contains insufficient data or parameters, database builder 120 is able to search and download necessary information or data from the cloud-based RCS network whereby the necessary data will enable to start of selected RCS. Upon modification of search terms by ML 218, transmitter 214, for example, transmits the modified search terms to the cloud-based RCS network via Internet 128. Once the data is obtained and verified by ML 218 and/or AI 220, database 122 is updated accordingly to facilitate the next turn of RCS. The term “turn” or “next move” refers to the process of RCS moving from one phase (block or event) to next phase (block or event) within a rail. A benefit of employ the dynamic loading method for database builder 120 is to provide more RCSs or games with the minimal requirement of local storage capacity.

Database 122, in one embodiment, stores various types of data and/or parameters for multiple RCSs. For example, database 122 stores information or parameters relating to wars 222, rails 224, maps 226, time 228, party1 or country1 230, armed force 232, industrial capacity 234, characters or culture traits 236, support 238, party2 230, and the like. Database 122 includes various wars or war theaters such as Yom Kippur 250 and/or WW II (World War Two) 252. For example, war of Yom Kippur 250 has rail parameter of day 2, map parameter of Sinai, time parameter of Oct. 7, 1973, party1 parameter of Israel, armed force parameter for party1 is 500,000, party1 industry parameter of advanced, party1 character parameter of trait 1, party 1 support parameter of USA, party2 of Arab countries, and the like. In one aspect, database 122 can store additional information, such as, but not limited to, total population, public sentiment/opinions, world opinions/resolutions, international supports, battalions of arm, warships, warplanes, tanks, artillery pieces, missiles, chemical weapons, and the like. A function of database 122 is to provide data or information as parameters to facilitate RCS such as Yom Kippur War day 2.

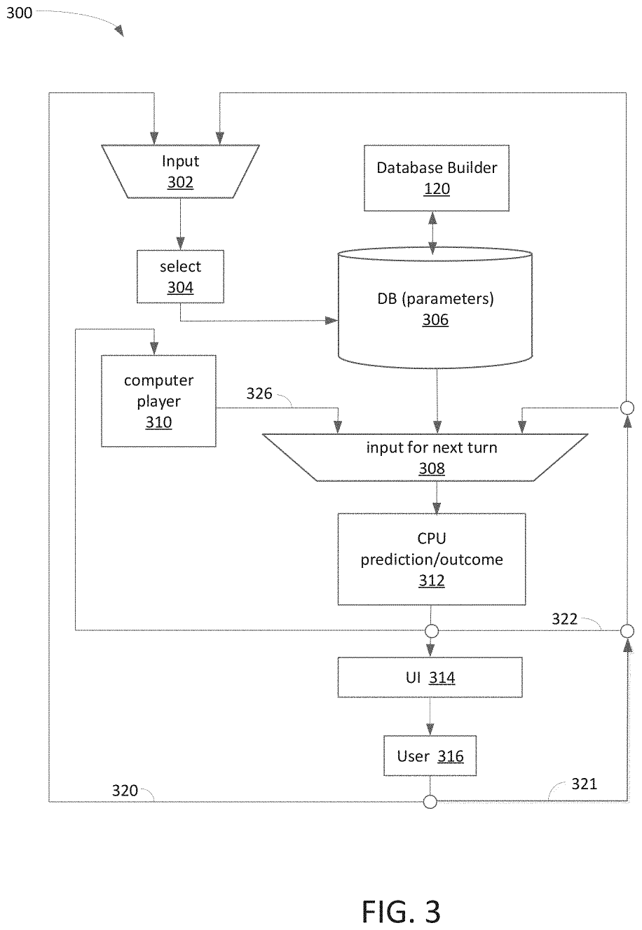

FIG. 3 is a logic block diagram 300 illustrating an exemplary process of emulating an RCS in accordance with established parameters in accordance with one or more embodiments of the present invention. Diagram 300 includes a database builder 120, DB 306, CPU 312, and user 316. Database builder 120, in one example, generates objects that are predefined by the nature of RCS and stored in DB 306 as parameter(s). For instance, if RCS is WWII, time duration parameter is predefined to between 1939 to 1945. It should be noted that the underlying concept of the exemplary embodiment(s) of the present invention would not change if one or more blocks (or networks) were added to or removed from diagram 300.

To initiate a selected RCS, user 316 is usually required to enter a set of players defined objects as indicated by numeral 320. For example, user 316 can select USA as a party1 parameter. After receipt of user input at input device 302, select module 304 identifies and stores user or player defined objects at DB 306 as parameters. Upon receiving inputs from user input 321, parameters from DB 306, and selections from computer player 310, input component 308 processes and passes processed inputs to CPU 312 for calculation. CPU 312, which provides action spontaneous random processing, initiates and processes game events autonomously using algorithms such as Monte Carlo method without players' input.

UI 324 is used to communicate with user 316. For example, UI 324 can be a computer terminal, computer monitor, smart phone, and/or portable pad capable of providing interface between user 316 and CPU 312. In one aspect, CPU 312 outputs an outcome based on the input parameters. In one aspect, CPU 312 is capable of providing automatic time passage which can be automatically timed or turned based on a predefined time duration.

The RCS system, in one embodiment, is able to create a game that is historically accurate and follows the actual historical events. For example, the RCS system provides computer simulation of historical war processes. To provide an RCS, various mathematical algorithms are used to calculate the chances of winning one or more battles based on a range of input parameters like, number of soldiers on both sides, level of training, morale, supply levels of ammunition and gasoline, surprise level, et cetera. To visualize a war theater, a set of interactive maps are used to reflect the progress of the game.

In one example, a battle algorithm uses at least partially Monte Carlo algorithm with a series of lookup tables for reading values or parameters and plots curves showing war theater. The curves represent relationship between various parts of parameters. For example, curves showing duration of a battle can be a function of ratio between two forces involved. The RCS further includes a large number of scenarios which can be described as “alternative history” scenarios which can be hypothetical possibilities that could change the historical events. For example, if a preemptive strike was initiated, the outcome of Yom Kippur war could be different.

An advantage of using an RCS system is that it presents a historical event or events that had happened. Another advantage is that the RCS system can be teaching tool or predicting tools to provide past, current, and future predictions based on the parameters.

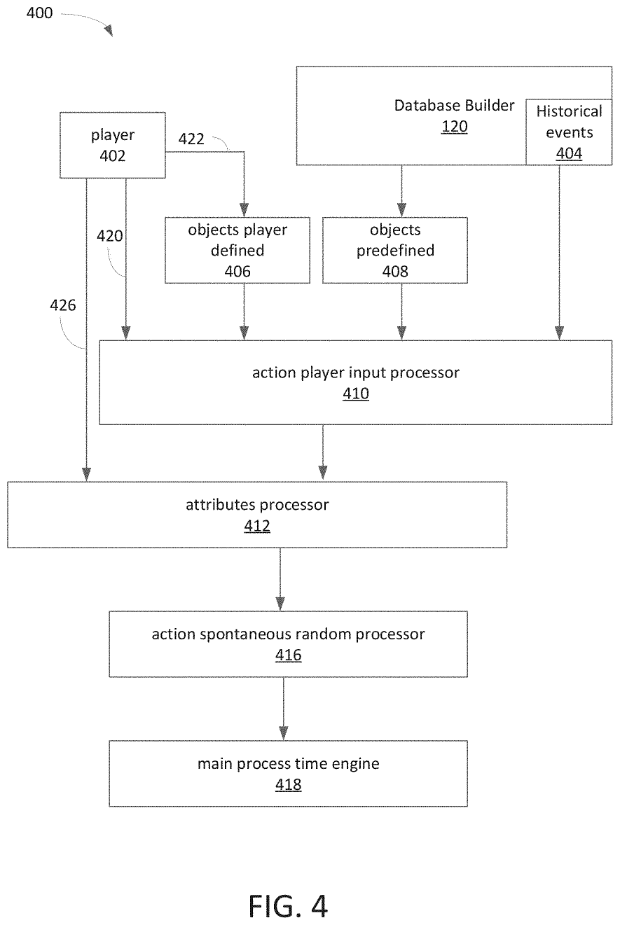

FIG. 4 is a logic block diagram 400 illustrating an alternative logic flow for emulating RCS in accordance with one or more embodiments of the present invention. Diagram 400 includes database builder 120, action player input processor 410, attributes processor 412, and player 402. Database builder 120, in one example, includes historical events and objects that are predefined for one or more RCSs. For instance, if a selected RCS is the second day of Yom Kippur war, time parameter which is predefined to be Oct. 7, 1973 is identified and fetched. It should be noted that the underlying concept of the exemplary embodiment(s) of the present invention would not change if one or more blocks (or networks) were added to or removed from diagram 400.

Player 402, also known as user, initiates an RCS as indicated by numeral 420 and enters a set of player-defined objects as indicated by numeral 422. After receipt of player 402 request for initiating the RCS, action player input processor 410 input obtains historical data or events 404 as simulation parameters from database builder 120. Upon obtaining player-defined objects 406 and objects predefined 408 from database builder 120, action player input processor 410 processes and forwards received data or parameters to attributes processor 412. Based on player or user input 426, attributes processor 412 processes and provides various processed parameters to action spontaneous random processor 416 in accordance player input 426, historical events 404, identified objects 406-408, and the like.

Action spontaneous random processor 416 initiates and processes game events autonomously using algorithms such as Monte Carlo method with or without players' input. After generating an outcome based on various processed parameters, the outcome is subsequently displayed to and/or communicated with player 402. After generating the outcome(s), the process proceeds to main process time engine 418. Depending on the applications and player's input(s), main process time engine 418 maintains and controls logic flow of the RCS or game.

Building Rail Tree

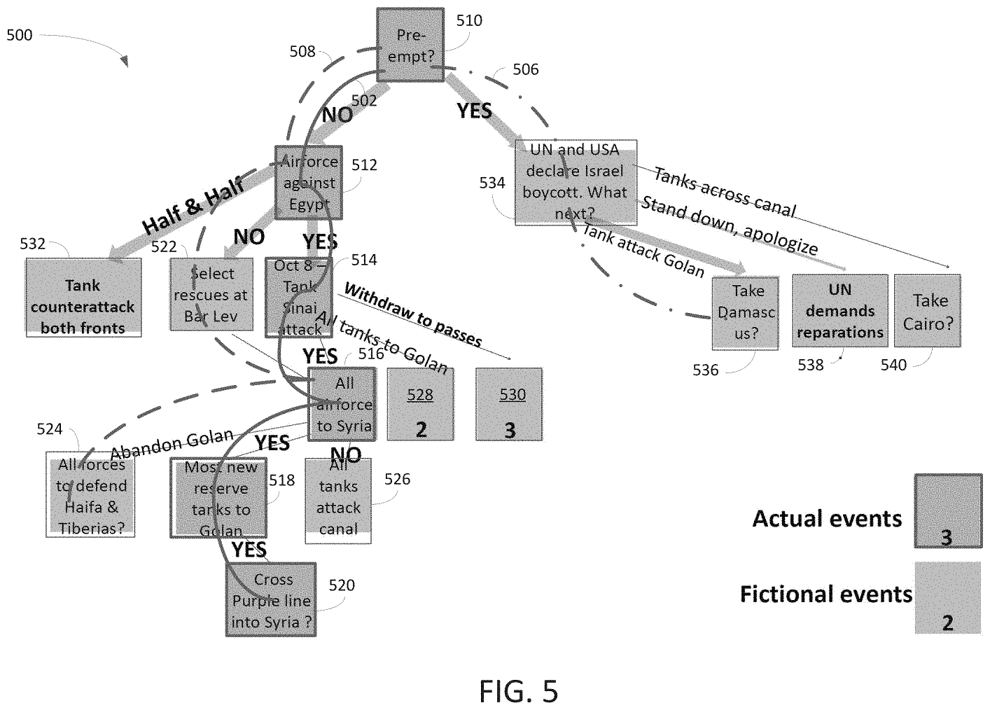

FIG. 5 is an event tree diagram 500 illustrating an exemplary rail tree containing multiple rails for emulating RCS in accordance with one or more embodiments of the present invention. Diagram 500 illustrates multiple possible rails or paths from block 510 including rails 502-508. A rail can be referred to as a sequence of actual or potential events based on a predefined time frame. In one aspect, rail 502 is an actual event that had happened in the past. It should be noted that the underlying concept of the exemplary embodiment(s) of the present invention would not change if one or more blocks (or networks) were added to or removed from diagram 500.

In one aspect, rail 502 includes blocks 510-520 representing actual events. For instance, at block 510, a player decides whether a preempt strike should be launched before Oct. 6, 1973 assuming the RCS is Yom Kippur War. Upon entering a “NO” option by the player, the process proceeds to block 512 in which Israel Defense Force (“IDF”) air force is activated against Egyptian force. After IDF tanks, at block 514, attack in Sinai if the player elects, IDF air force engages in Syria at block 516. Once the IDF reserved tanks, at block 518, enter Golan Heights on Egypt side, the IDF force, at block 520, crosses the border into Syria. It should be noted that a player is required to enter a selection at each block to move forward with RCS on a rail. Rail 502, in one aspect, is an actual historical recount of various events during Yom Kippur War.

Rail 506, in one example, illustrates a hypothetical or fictional path of events based on various parameters including experts' predictions and/or possibilities. Rail 506 includes blocks 510 and 534-536. For instance, at block 510, a player decides whether a preempt strike should be launched assuming the RCS is Yom Kippur War. Upon entering a “YES” option by the player, the process proceeds to block 510 in which IDF force launches a preemptive strike on Arab's forces. While, at block 534, the United Nations and the United States are likely to declare some kinds of boycott and/or sanctions, the IDF force is likely to take Golan Heights and Damascus using tanks and air force. Alternatively, the IDF force may send tanks across canal to reach Cairo at block 540 despite the boycotts by the UN and the US at block 534.

Rail 508, in one aspect, illustrates a hybrid path combining some actual events and some hypothetical events based on various parameters generated based on historical data as well as experts' predictions. For instance, at block 510, a player decides whether a preempt strike should be launched assuming the RCS is Yom Kippur War before Oct. 6, 1973. Upon entering a “NO” option by the player, the process proceeds to block 512 in which IDF air force decides not to engage against Egyptian force. After IDF, at block 514, selects to rescue and/or protect the Bar-Lev line, IDF air force engages in Syria at block 516. At block 524, the IDF, based on the player's selection, orders all force to defend Haifa and/or Tiberias. It should be noted that the player is required to enter a selection at each block to move forward with RCS. Rail 508 shows combination paths of some real events and some hypothetical events based on a historical data such as Yom Kippur War.

Backpack of Variables

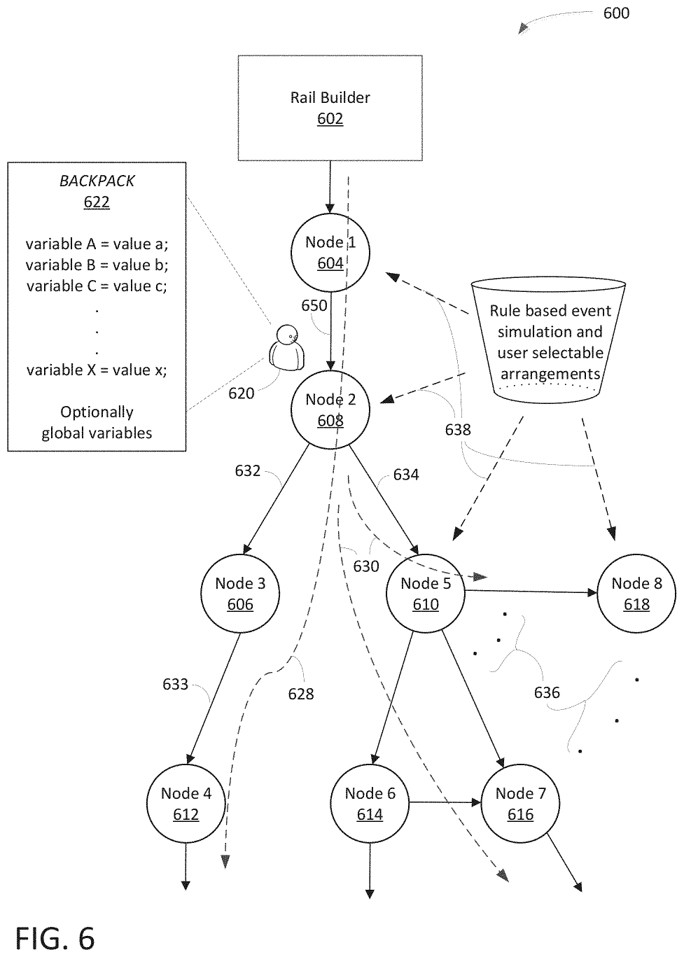

FIG. 6 is a block diagram 600 illustrating a rail tree containing multiple rails and nodes in a theater emulated via RCS in accordance with one or more embodiments of the present invention. Diagram 600 includes a rail builder 602, a user or player 620, a trail tree containing a first rail 628, a second rail 630. In one aspect, diagram 600 further includes a backpack 622 assigned to user 620. It should be noted that the underlying concept of the exemplary embodiment(s) of the present invention would not change if one or more blocks (or nodes) were added to or removed from diagram 600.

A video game system, in one embodiment, using RCS simulates a battle field based on at least in part on historical events. The system simulates rails containing multiple conflicting nodes or events based on in part historical theaters for a player or user to fight or walk through via a fighting force. While a rail or rails representing a sequence of conflicting path(s) in a historical recorded battle, the nodes along the rail(s) represent battles, fighting, and/or conflicts along the rail(s). When a player or user elects himself or herself as a commander of in force, the system assigns a backpack of variables to the player as his or her resources for fighting through the node. The player's resources include, but not limited to, armed force, morals, national opinions, international supports, and supplies. The resource allocated to each player or user is at least in part represented by values of variables assigned to each player. After offering an option to the player or user for rearranging player's fighting capabilities, the system generates a score or outcome which assesses player's real-time decision-making capabilities.

Upon election of a particular battle field or theater, rail builder 602 is able to build a selected battle field using rails 628-630 and nodes 604-618. Rail builder 602, in one embodiment, includes a database builder, a database, and a processor. In one example, the RCS system is able to obtain data from local storage, remote storage, and/or online resources via networks.

A rail tree contains multiple rails 628-630 including point-to-point (“PTP”) nodes such as node 604-606 and node splitters 608-610. PTP nodes 604-606 and splitter nodes 608-610, in one embodiment, are similar nodes representing events along a rail or rails based on historical events and/or actual geographic terrains. PTP node such as node 606 has one up-node connection 632 and one lower-node connection 633. Splitter node such as node 608, on the other hand, includes one up-connection 650 and two lower-node connections 632-634.

A function of PTP node such node 604 is able to facilitate a player such as user 620 to move from node 604 to node 608 with user's variables in backpack 622. For example, if a battalion of soldiers has left behind in node 1 604, the RCS system updates some values of variables associated to user 620 to reflect that user 620 has less soldiers. It should be noted that each node is operable via rule-based event simulation and user selectable arrangements as indicated by numeral 638.

The splitter node such as node 608, in one embodiment, provides an option to a player such as user 620 to whether staying on the original rail such as rail 628 or branching off to a new rail such as rail 630. In some examples, splitter node such as node 610 can branch to one of multiple rails as indicated by numeral 636. In one example, node-5 610 can lead a user to node-6, node-7, or node-8 depending on rail results calculated by a prediction simulator using, for example, the Monte Carlo method in response to values of variables assigned to user 620.

Backpack 622, in one aspect, includes a group of variables associated to a particular user such as user 620. Each variable such as variable-A contains value a. Value a can be a real or imaginary number. In one example, backpack 622 or bag of variables is assigned to a player such as user 620 and backpack 622 follows the player walking along the rails. The player, for instance, travels (or fights through the battle field) on pre-designed event rails and carries backpack 622 representing t player's available resources. The player or user 620 carries backpack 622 moving between the nodes on rails emulated by the system. The system, in one aspect, using a computational game calculator calculates results or outcomes of a battle using the Monte Carlo algorithm. In order to generate (or force) an outcome for the nodes on rails, the RCS system herds the data given by the algorithm through variable range gates and backs onto pre-defined rails.

Variables in backpack 622, in one example, are set to store real numbers, imaginary numbers, or a combination of real and imaginary numbers. It should be noted that initial values or numbers for the variables are defined by the RCS system. The values of variables represent at least in part the fighting strength associated to the player such as user 620. The values of variables also indicate the resources possessed by the player.

In operation, a process capable of facilitating user progress or movement on a rail such as rail 628 emulated by RCS simulates rail 628 containing node-1 604 to node-4 612 emulating a theater or a battle field in accordance with at least in part on the recorded historical facts. After facilitating a player or user 620 traveling on rail 628 approaching to an event or node-2 608 from a first direction such as a direction from node-1 to node-2, and a second player, not shown in FIG. 6, traveling on rail 628 approaching to node-2 from a second direction such as a direction from node-3 606 to node-2 608, resource options are presented to players for rearranging, upgrading, downgrading, and/or reenforcing their resources and/or weaponries based on players' resources and movements. It should be noted that rearranging players resources include trading their values of variables in their backpack for weapons and soldiers. Upon engagement of the node or battles, scores and/or outcomes are generated based on a prediction calculation using a Monte Carlo simulator as well as global variables.

The RCS system, in one aspect, is capable of maintaining continuous existence of a unit even if the unit is substantially destroyed in the battle or node. The crippled or destroyed unit, in one example, can be replenished at a later time based on a set of predefined rules. A benefit for a unit to be immortal is that the unit or its name of unit such as the fifth army can still exist even though there is no one left in the unit at the moment.

The unit immortality, in one embodiment, is a unit (e.g., military entity) which can get severely damaged in battle but never gets completely destroyed or disappeared. For example, a unit identifier (“ID”) will continue to exist even if all soldiers and/or assets are completely vanished. When soldiers in a battalion or squadron in air force have been destroyed, its unit IDs, however, still exist. For example, army can mobilize new recruits or transfer soldiers from other units to replenish the understaffed and/or under supplied units. The RCS system, in one embodiment, maintains units which could incur heavy losses but will not be eliminated or wiped out from the game maps.

Backpack 622, in one embodiment, further includes one or more global variables. Global variables, for example, can change outcome(s) for the battle based on events and player's decisions. For example, during a simulation of Yom Kippur war, the global variables may include Israel economy status, international support to Israel, Israeli public morale, Egypt public morale, Syrian public morale, American policies towards Israel and Arabs, and/or Russian foreign and military policies toward Arabs and Israel. The RCS system allows the global variables visible to player(s) throughout the game via an icon labeled, for example, “global variables.” While such global variables may be controlled by the player through his or her conduct and/or decisions, the global variables can always change over time based on events that happen during the course of battle. For example, a player could choose to bomb Damascus which would result in change of global variables. Also, when Egyptian army attacks Israel which may not be controlled by the player, the values of global variables for the player who plays on behalf of Egyptian army may change. When variables reach certain levels or values, the global variables can trigger the start of predesignated events. For example, if the value of global variable for American policy towards Israel goes above certain level, a military airlifting takes place. Alternatively, if the value of global variable for American policy towards Israel stays at a certain level, no airlifting occurs.

Depending on the values of variables including global variables in backpack, the RCS system employs one or more rule-based variable processors to predict a likelihood outcome based on a prediction algorithm such as Monte Carlo method.

An advantage of using values of variables associated to each player is to allow the simulation system using mathematical formulars such as Monte Carlo method to predict a likelihood outcome based on the player's decision as well as historical facts.

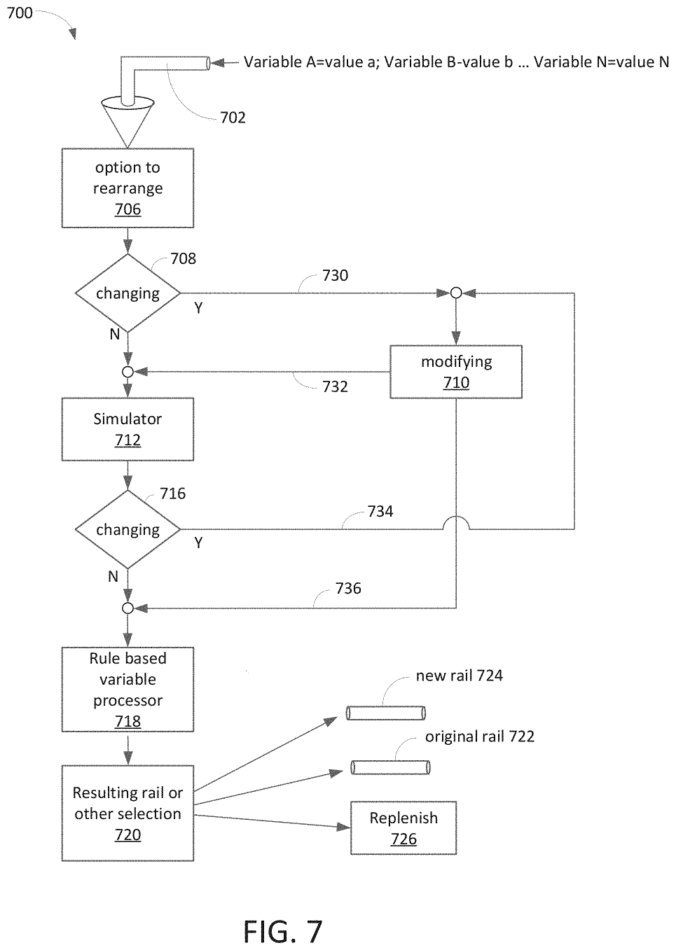

FIG. 7 is a logic block diagram 700 illustrating a process of moving or progressing a player between nodes on a rail emulating by RCS in accordance with one or more embodiments of the present invention. To facilitate movement or progress a game player or user from one node to another, the RCS system activates a variable accumulator 702 for obtaining values corresponding to variables associated to each player. It should be noted that the values can be real-numbers, imaginary numbers, and/or combination of real and imaginary numbers. The terms “player”, “game player”, and “user” are referred to the same or similar person and they can be used interchangeably. It should be noted that the underlying concept of the exemplary embodiment(s) of the present invention would not change if one or more blocks (or nodes) were added to or removed from diagram 700.

Upon obtaining variables from backpack associated to a player, an option to rearrange player's assets or resource is presented to the player at block 706. If the player elects to change or rearrange his or her resource or assets at block 708, the process proceeds to modifying block 710 as indicated by numeral 730. For example, the player can add another battalion of soldiers using some of the values of variables in the backpack. After modification, the process proceeds to simulator block 712 as indicated by numeral 732. If, however, the player declines to rearrange player's assets, the process proceeds to simulator block 712. It should be noted that the player's asset possession or player's asset refers to player's armed force including, but not limited to, number of fighters, ships, tanks, battalion of soldiers, supplies, and the like. Simulator block 712 includes a Monte Carlo prediction simulator capable of predicting a likelihood outcome in light of values of variables and other player's resources at the node.

After simulating an outcome, the process proceeds to block 716 to present an option to the player offering another opportunity to rearrange or modify player's resource or assets. If the player elects the option to modify at block 716, the player can rearrange or modify player's assets to prepare for the next node or event as indicated by numeral 734. Upon rearrangement or modification, the process proceeds to block 718 as indicated by numeral 736. If, the player elects not to rearrange or modify at block 716, the process proceeds to block 718.

At block 718, a rule-based variable processor is used to calculate the next node as well as connections on the rail that the player can be on based on rules, outcome of simulator block 712, and variables from all players. In one aspect, block 718 generates one or more results for each player to facilitate navigation of player's next node. Based on the result(s) of calculation, the resulting rail and/or other selection(s) are automatically elected at block 720 for the player. For example, the player may be able to remain on the original trial 722 if the result for the player reaches to a predefined level. Alternatively, the player may be forced to move onto a new rail 724 if the score for the player fails to reach to the predefined level. In another embodiment, the player is entitled to replenish his/her resource at block 726 based on a set of predefined rules.

The RCS system, in one aspect, is capable of providing a score or scores for each player at the end of video game. Based on various fronts or factors, a score or report is generated at the end of game based on the rules, resource consumed, casualties, damages, territorial gains, international influences, and city or territorial loss. For example, during RCS based on the 1973 Yom Kippur War, a final report, such as Agranat Commission Report, is generated summarizing various fronts, such as, but not limited to, Sinai, Golan, Russia, the US, and diplomatic resolution(s). At the end of each game, the player, for example, receives an ending result for each front. Such ending results, in one aspect, would be used, accumulated, and combined into the final report (or Agranat Commission Report) to generate players' overall scores. In one embodiment, the RCS system provides an opportunity for the player to compare his/her campaign records against the actual Agranat Commission report generated by the historical commission.

It should be noted that global variables can affect player's overall numerical score. For example, the score is formulated into one single number which ranks player's performance. Analyzing and ranking players' performance allow the RCS system to analyze player's dynamic real-time performance rather than a system defined outcome.

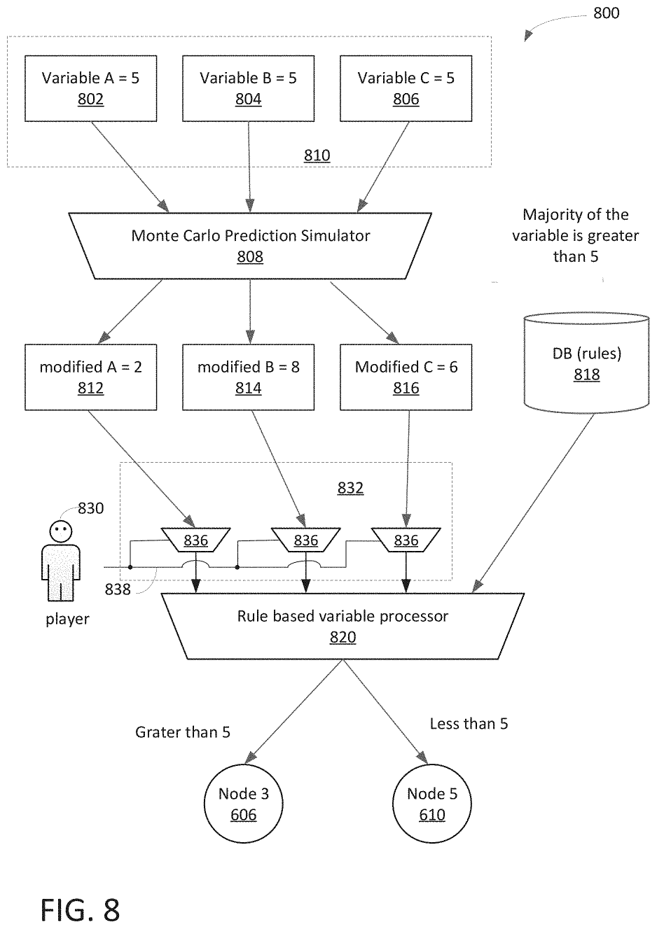

FIG. 8 is a block diagram 800 illustrating an exemplary logic process progressing between nodes on one or more rails under RCS in accordance with one or more embodiments of the present invention. Diagram 800 includes backpack 810, Monte Carlo Prediction Simulator 808, rule database (“DB”), and rule-based variable processor 820. In one aspect, backpack 810 is designated to player 830 to walk through a rail. Note that the most of steps illustrated in diagram 800 are generally performed for every node on a rail. It should be noted that the underlying concept of the exemplary embodiment(s) of the present invention would not change if one or more blocks (or nodes) were added to or removed from diagram 800.

Backpack 810 includes a group of variables wherein each variable may contain a value. In the presently disclosed exemplary embodiment, backpack 810 contains variable-A 802, variable-B 804, and variable-C 806. In this example, variable-A 802, variable-B 804, and variable-C 806 are initially set to value 5. Upon obtaining variable-A 802, variable-B 804, and variable-C 806, prediction simulator 808 calculates and/or modifies variable-A, variable-B, and variable-C using the Monte Carlo method. Prediction simulator 808 subsequently generates a modified variable-A containing a number 2, modified variable-B containing a number 8, and modified variable-C containing a number 6 as indicated by numerals 812-816.

At block 832, an option to rearrange or update values of variable is offered to player 830. For example, player 830 can trade up or exchange his or her armed force before engaging in the event or battle at the node. It should be noted that armed force upgrade or downgrade is reflected by the values of variables. Variable updating components 836 are controlled by player 830 via control connections 838. Player 830, in one example, is provided an opportunity to update or rearrange player's values of variables before reaching to rule-based variable processor 820.

After fetching a set of rules from rule DB 818, rule-based variable processor 820 calculates and generates a result based on the values of variables and the rules. The result, also known as value of resulting rail, is a number that determines which node will be the next node for the player to move to. For example, if the result is great than 5, the next node will be node-3 606. If, however, the result is equal or less than 5, the next node for the player will be node-5 610.

Rule DB 818, in one embodiment, contains a set of rules for every node on each rail wherein a node represents an event based on a historical event. A node, in one aspect, represents an event which illustrates a predefined duration of a battle or fight partially based on historical facts as well as actual geographic terrain. For a player traveling through a node which indicates a fighting through the geographic terrain against one or more hostile forces, a likelihood outcome or result after the battle is generated or predicted via a prediction method such as Monte Carlo method. The prediction method is performed by rule-based variable processor 820 according to the rules and player's armed force reflected by the variables in backpack after engagement of the battle. Depending on the player's election and/or real-time performance, the outcome or result shows at least in part a score of player's cognitive performance.

In operation, a video game using RCS receives and/or collects inputs or requests from a user or player requesting activation of a particular rail of a theater emulating a historical war. For instance, a player can enter a request to play the day-3 at Migdal battle field as a commander of Israeli air force during the 1973 Yom Kippur war. Upon facilitating the user or player to travel on the rail approaching to the battle field, RCS obtains variables containing values in a variable backpack designated to the user or player. RCS offers opportunities for the player to rearrange and/or modify his or her armed force or regiment. For example, RCS presents a resource option to the player allowing an option of modification or exchange a portion of values of variables to upgrade user's weaponry. After activating a computational module to calculate a set of updated values associated to the variables in response to the modification, an outcome or result of the battle is scored in response to a set of rules and the set of updated values.

An advantage of using rules and values of variables is that it can enhance accuracy of predication of a likelihood outcome using mathematical formulars for a battle field. The likelihood outcome can be predicated for the wars occurred in the past as well as in the future depending on the applications.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

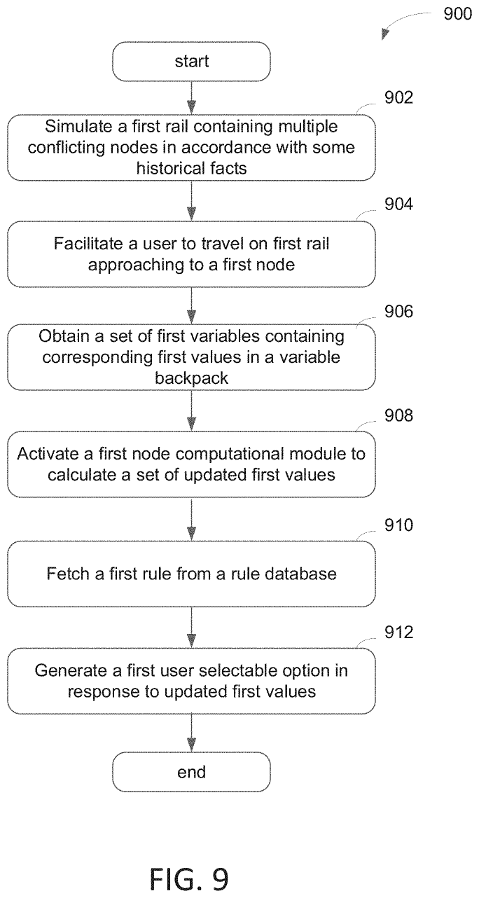

FIG. 9 is a flowchart 900 illustrating an exemplary process of RCS emulating a player's progress or movement between nodes on a rail in accordance with one embodiment of the present invention. At block 902, a process capable of facilitating a movement or progress of a player on a rail with a sequence of events or nodes emulated by RCS provides a selected rail containing multiple conflicting nodes emulating a theater in accordance with at least in part based on recorded historical facts. The rail, in one example, includes one or more rail splitters along the rail for branching to one or more new rails.

At block 904, the player or user travels on the rail approaching to one of the conflicting nodes. In one aspect, the process is able to identify a location along the rail in which the user or player is currently on. In one embodiment, the RCS system is capable of superimposing the player's current location over a map showing geographic attributes of a battle field.

At block, 906, the process obtains multiple variables having corresponding values in a variable backpack which is designated to the user or player. It should be noted that the values of variables can be integer, real-number, imaginary number, and/or a combination of integer, real-number, and imaginary number.

At block 908, a computational module at the node is activated to calculate a set of updated or modified values associated to the variables in response to the corresponding values. In one aspect, the process initiates an estimator based on the Monte Carlo method to facilitate generation of the updated or modified values in accordance with input parameters and predefined rules associated to the node. The parameters, in one example, includes number of soldiers, weapons, morals, and/or supplies based on at least in part on historical facts.

At block 910, a set of rules are fetched from a rule DB based on the node. In one aspect, the rule DB stores rules for each node on the rail. In one example, rules are used to reflect the battle conditions, armed forces, geographic terrains, public opinions, an soldiers' moral at least in part based on historical facts.

At block 912, the player is offered an option to rearrange or reenforce player's fighting capabilities based on values of variables. For example, the player may modify or alter his or her military assets for continuing staying on the current rail based on the arrangement of hostile forces. Alternatively, the player can rearrange his or her regiment based on opposing force for taking the split option to a new rail. After detecting the player and electing rail, an elected RCS environment containing the rail is simulated at least partially based on historical facts. RCS, in one aspect, is also capable of facilitating a second user or player to travel on the rail approaching to the node from an opposite direction. In operation, after identifying and creating an environment to simulate a selected theater, a map containing geographic parameter associated with the theater is generated in accordance with geography relating to the historical event. Upon generating armed force as a military parameter associated with the user or player in accordance with the historical event, a map storage for storing the relevant maps and armed force storage for storing the soldiers are created in the local system.

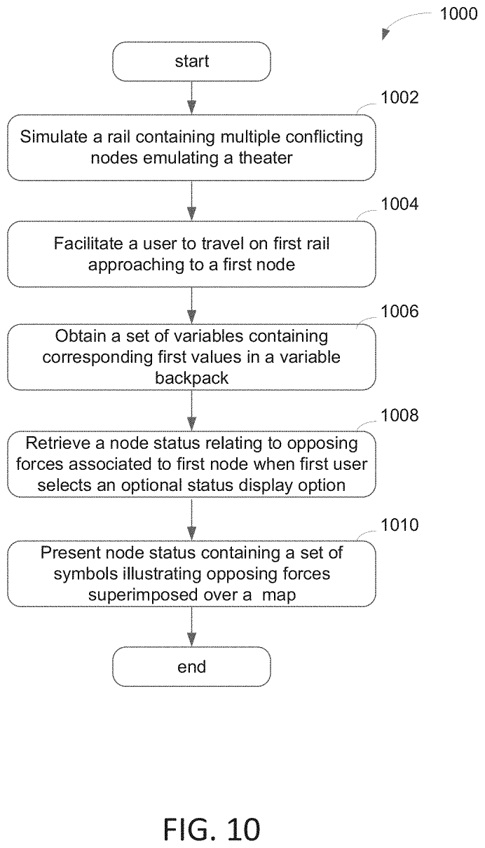

FIG. 10 is a flowchart 1000 illustrating an exemplary process of RCS emulating symbols superimposed over a map showing movements between nodes on a rail in accordance with one embodiment of the present invention. At block 1002, a process capable of facilitating progress of a player on a rail simulates a rail containing multiple conflicting nodes emulating a theater in accordance with historical facts.

At block 1004, the player or user is facilitated to travel on the rail approaching to a destination node.

At block 1006, the process obtains a set of variables containing corresponding values in a variable backpack designated to the player or user.

At block 1008, a node status relating to the opposing or hostile forces associated to the node is retrieved when the user selects an optional status display option.

At block 1010, the node status containing symbols illustrating the opposing forces superimposed over the map is presented. In one example, the process presents the optional status display option allowing the player or user to elect. In one example, the size of a symbol representing strength of a forces is displayed. For instance, a bigger symbol representing the opposing force indicates that the opposing force has a larger force. An arrow symbol represents the origin of a force.

X-Maps

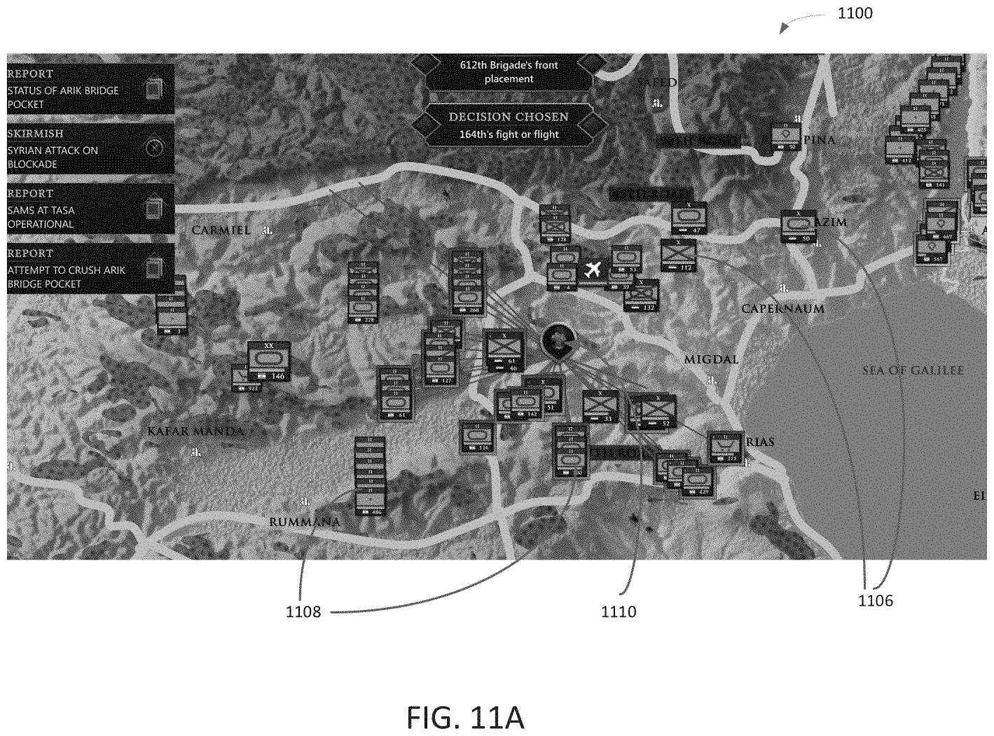

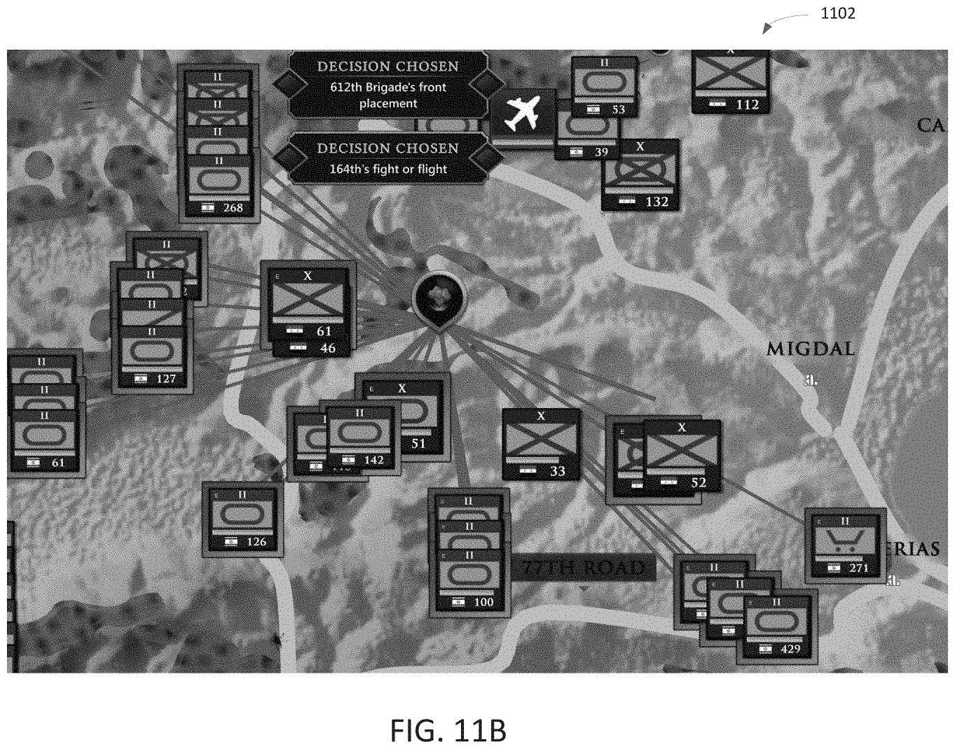

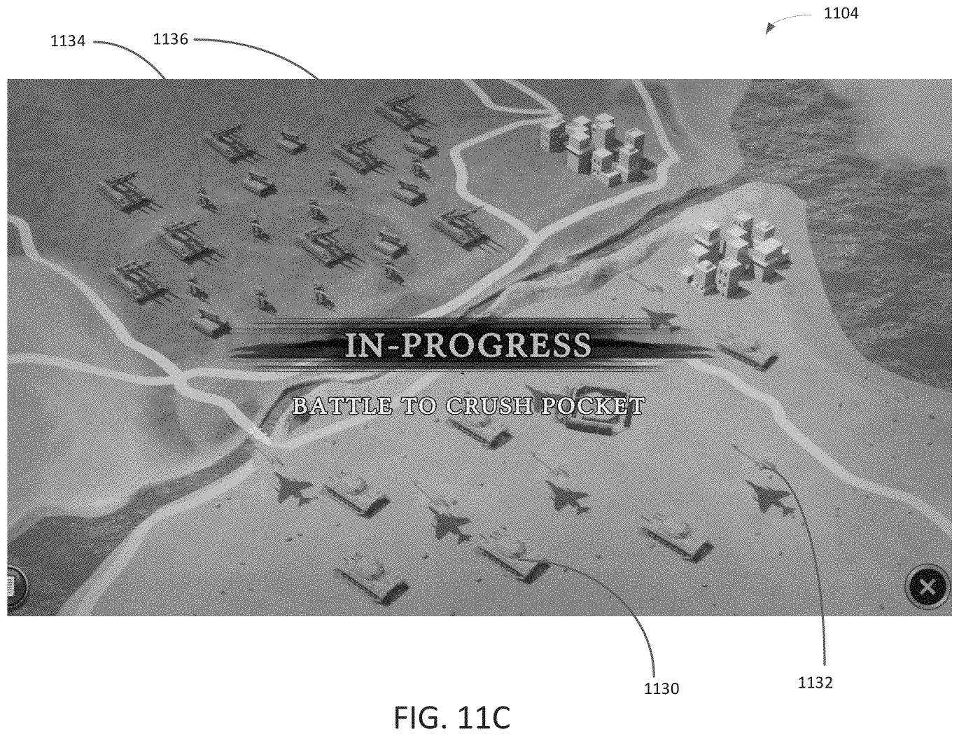

FIG. 11A is a map 1100 containing geographic terrains illustrating a battle field having symbols superimposed over the map in accordance with one embodiment of the present invention. Map 1100 illustrates a battle field around Migdal during 1973 Yom Kippur war. Map 1100 illustrates red blocks 1106 representing Arab forces while blue blocks representing Israeli forces 1108. The Arab forces and Israeli forces were engaged at node 1110. Map 1100 illustrates an exemplary map that allows symbols such as fighter squadrons and/or army units to superimpose over a map. RCS, in one embodiment, offers an icon of map to the player and the player can click the icon at any time to bring up the map such as map 1100 to evaluate the status of engagement. It should be noted that the underlying concept of the exemplary embodiment(s) of the present invention would not change if one or more blocks (or symbols) were added to or removed from map 1100.

It should be noted that on the live game map, there are objects (special vehicles and other movable systems) that while in motion might be non-operational. These objects, after arriving at their stationary destination, need some preparation time before they can be activated. For example, a movable missile truck is not able to fire its missile while in transit. Once arrival at the battle field, the missile truck, for example, needs a two-hour setup time for the missile to be operational. Such objects, also known as entities, have their parameters programmable; in particular, speed of travel, time needed to make the unit operational after the travel, degree of its inoperability (unit might be only partially, ex. 50% inoperable), time to repair a damaged unit, time needed for maintenance of the unit, range of fuel needed to make unit operable. In one embodiment, such objects can be presented in the live game map or map to show such hardware or entities with operational indicators.

FIG. 11B is a map 1102 containing geographic terrains illustrating a battle field having symbols superimposed over the map in accordance with one embodiment of the present invention. Map 1102 is a zoom-in or magnified section of map 1100 shown in FIG. 11A. In one aspect, RCS allows a player or user to enlarge or zoom in the map to see additional details relating to various forces and movement around the node or battle field. In another embodiment, RCS also provides an option to zoom out whereby the player can see additional troops movements in a larger geographic area.

FIG. 11C is a map 1104 containing geographic terrains illustrating an engagement of two forces in a battle field having symbols with a three-dimensional (“3D”) effect superimposed over a map in accordance with one embodiment of the present invention. In one embodiment, red force 1134-1136 is prepared to cross a river while blue force 1130-1132 is trying to engage with red force 1134-1136. With a 3D live game map, a player is able to make a better decision when various attributes relating to forces 1130-1136 are illustrated. For example, red force 1134-1136 has more soldiers 1134 backed by missiles 1136 while blue force contains tanks 1130 supported by aircrafts 1132. Depending on the player's judgement, he or she may reenforce additional forces to obtain a better outcome or a higher score.

Film Mode

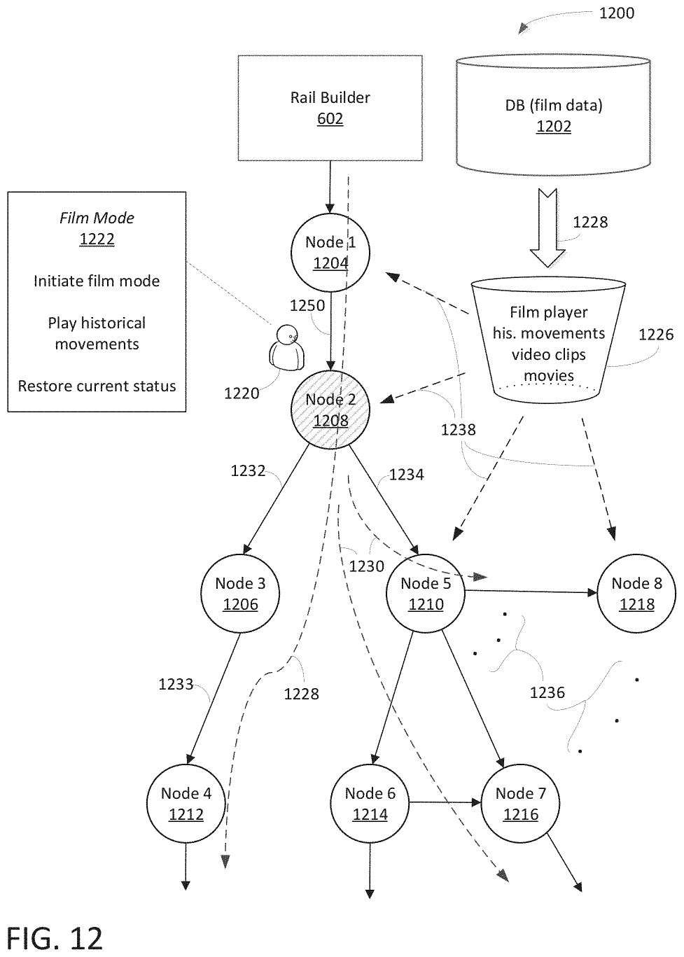

FIG. 12 is a block diagram 1200 illustrating a video game hosted or facilitated by an RCS system containing a film mode capable of playing a film showing a historical battle in accordance with one or more embodiments of the present invention. Diagram 1200 includes a rail builder 602, a user or player 1220, a tree containing multiple rails including a first rail 1228 and second rail 1230. In one aspect, a film mode 1222 is presented on the screen of the video that allows a user or player 1220 to optionally select as to whether a film mode should be activated, plus all the other options like record film option from the user's play, select from which character vantage point one wants to view the film play etc. It should be noted that the underlying concept of the exemplary embodiment(s) of the present invention would not change if one or more blocks (or nodes) were added to or removed from diagram 1200.

The RCS system, in one embodiment, provides or simulates a video game emulating a battle field based on at least in part on historical recorded events. The battle field illustrated in diagram 1200 provides multiple rails 1228-1230 wherein each rail may contain conflicting nodes (or events) as well as additional new rails breaching out to new directions or paths based on at least in part a historical war theater(s). Each game player or user chooses a role within the battle field to play the game. For example, the role can be a tank commander, a fighter pilot, a civilian, a reporter, an army general, and the like. While a rail or rails 1228-1230 representing a sequence of conflicting path(s) or events in a historical theater(s), the nodes along the rail(s) represent battles, fighting, preparing, and/or resting along the rail(s). When a player chooses a role such as a commander of brigade, the RCS system or simulator assigns a backpack of variables to the player as his or her resources for the game fighting through the node(s). The system will allow to generate film, on the fly, that shows the historical (or even fictional) story, from the different point of view, depending on the chosen role. Therefore, if the player has selected a role of tank commander, a fighter pilot, a civilian, a reporter, etc. then the film will play in a continuous film fashion, a version of the story as seen from the perspective of the chosen character like tank commander, a fighter pilot, a civilian, a reporter, etc. In effect the game will play, but the player input will be substituted by the input from the game system file that contains, prepared, ahead of time, all the proper player inputs. The access to the file with prepared player inputs, can be prepared by the player also. Player can just play the game in a standard fashion and turn on the RECORD mode to record the play and then will be able to play it in the film fashion.

The RCS system illustrated in diagram 1200, in one embodiment, includes a film mode 1222, a film player 1226, and a database (DB) 1202 containing film data. A function of film mode 1222 is to introduce or play one or more historical battles, combats, conflicts, and/or wars. A purpose for providing a film mode 1222 is to allow a player who is not familiar with the history of relevant war associated with the game to watch or be familiar with the historical events. Knowing the historical events would enhance the interest in playing the game. It should be noted that an object of the game may be to explore a possible alternative outcome of the battle or war if the historical event(s) or steps were altered.

For example, if a player is unfamiliar with the historical scenario, it may not be interesting or even possible for her or him to play and explore the various alternative historical options during the game. To remedy this shortcoming, the video game provides a passive film playing mode or film mode 1222 to educate the history relevant to the game. An operation of the film mode is to replace player inputs with automatic inputs that lead the game playing or traveling along the historically accurate scenario. The game converts into a film that depicts the actual history of a given war or conflict. The player or player 1220, in one aspect, is encouraged to watch such film(s) before playing the game to gain sufficient knowledge relating to the historical war or battles whereby to enhance the interest of playing the game.

Film mode 1222, in one aspect, is capable of initiating a historical film movie when a player such as player 1220 click the film mode button or icon on the screen of the video game. A process of the film mode 1220, for example, plays historical moves on the battle field depicted by diagram 1200 moving from one node to the next. In one embodiment, each movement between nodes such as from node 1 to node 2, a short clip or video clip is displayed on the screen to explain or describe the historical event. After playing the film representing historical movements, the status of the game restores to the situation before the playing of the film. The film can play from an arbitrary chosen point in the film, not just from the beginning. The film can be stopped at any place and then the game resumes from that place. During play of the game, one can switch back to the film mode, thus one can go back and forth. This will allow for a very interactive lesson of history or any other story like knowledge that can be conveyed to the player in the off and on fashion, allowing the user to watch a story and then interrupt it to influence its progress.

During an operation, upon clicking the option of film mode 1222, the RCS system activates film player 1226 to play the film at or around the node currently the player or player 1220 is located. After retrieving or fetching, from DB 1202, the film data associated to the nodes or rail(s) currently the player is located, a portion of the film data containing historical movements, video clips, and/or moves associated to the node(s) is identified and/or downloaded. DB 1202 can be resided locally or remotely. Based on the film data, certain existing or current values associated to the nodes are replaced with the historical values so that the historical film can be played. For example, film player 1226 is able to identify and replace minimal number of values or inputs at the node(s) as long as the historical film can be played. Note that the game is likely to contain short clips of pre-recorded videos. These can also include documentary video footage. While playing our dynamically generated film, the relevant videos including the documentary clips, will be imbedded in the film that we are generating. After replacing the values associated to the nodes, film mode 1222 takes over the movements of rails 1228-1230 and various video clips or movies are played at the relevant nodes as indicated by numeral 1238. For example, if the historical movement involves node 1, node 2, node 5, node 8, and player 1220 is currently located at node 2, film player 1226 replaces earlier player entered values (by player 1220) at node 1 and node 2 with historical values. After setting the historical values at node 5 and node 8, the film is played. After playing the film, film player 1226 restores the replaced values at node 1 and node 2 with earlier entered inputs whereby allowing player 1220 to continue play the game. In an alternative embodiment, film player 1226 loads a shot movie or film representing historical events on node 1, node 2, node 5, and node 8, and plays the short movie to illustrate or explain the importance and/or sequence of the historical events or battle fields.

An advantage of providing a film mode is that after watching the film, a player(s) is likely to be ready to play or enter the battle presented in the video game using her/his invention and creativeness for more favorable outcomes.

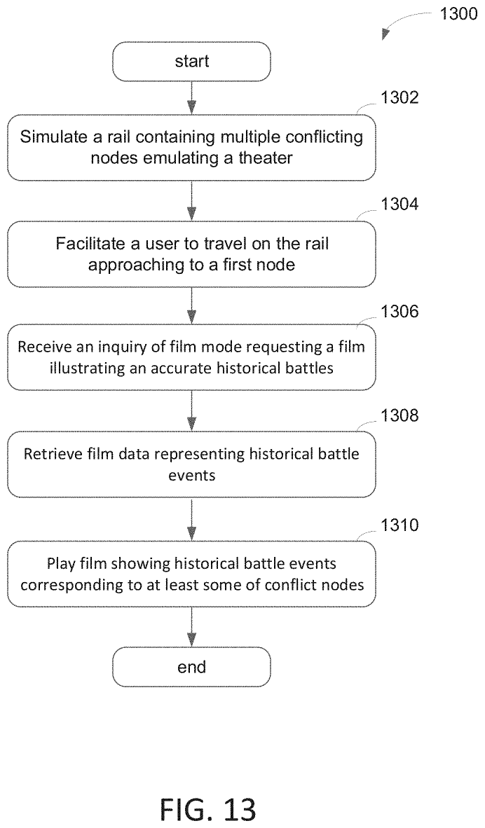

FIG. 13 is a flowchart 1300 illustrating an exemplary process of RCS having a film mode capable of playing a sequence of historical events in accordance with one embodiment of the present invention. At block 1302, a process of RCS system having a film mode is able to simulate a rail containing multiple conflicting nodes emulating a theater or war in accordance with at least a portion of recorded historical facts. The rail includes one or more rail splitters coupling to one or more new rails to mimic a historical battle field.

At block 1304, a user or player is facilitated by the RCS system to travel on the rail approaching to the next node or event of the conflicting nodes. In one example, the RCS system is able to identify the location of the player along the rail.

At block 1306, after clicking or selecting a film mode button or icon, an inquiry of film mode is activated for requesting a film illustrating an accurate account of a historical battle.

At block 1308, the process is capable of retrieving film data representing the historical battle events corresponding to the various conflicting nodes on the rail. In one example, a process of adjusting existing input data at some nodes is initiated in accordance with the film data.

At block 1310, upon replacement of automatic inputs in response to the film data, the process of RCS system plays a film showing and/or explaining importance, summary, and/or highlights of the historical battles or events corresponding to at least some of the conflict nodes on the rail. For example, the film facilitates automatic travel or path from one conflict node to another along the rail in accordance with the historical facts depicted or directed by the film data. After retrieving clip videos associated with at least some of the conflict nodes on the rail, a game subject relating to a historical war is introduced or played based on the recorded history. In one embodiment, after retrieving a stored video depicting actual history of battle associated to the rail, the video is played to explain historical events occurred at the conflict nodes along the rail. After playing the film, the original status of the rail immediately before initiating the film mode is restored so that the play(s) can continue playing the game.

An advantage of providing a film mode is to provide education value for history lessons while playing a video game. It should be noted that alternative approach to conduct certain battle fields or wars may result different outcomes.

It should be noted that copyrights to the existing Hollywood films or of any other type of movies or training films or instructional videos may be licensed so that the licensed films or videos can be converted into instructional training game and then build a game around these movie themes. These new games, based on the movies licensed from others, would be converted to the game that can play parts of it as films and parts as a game, on and off, as per our explanation above.

Timeline Normalization

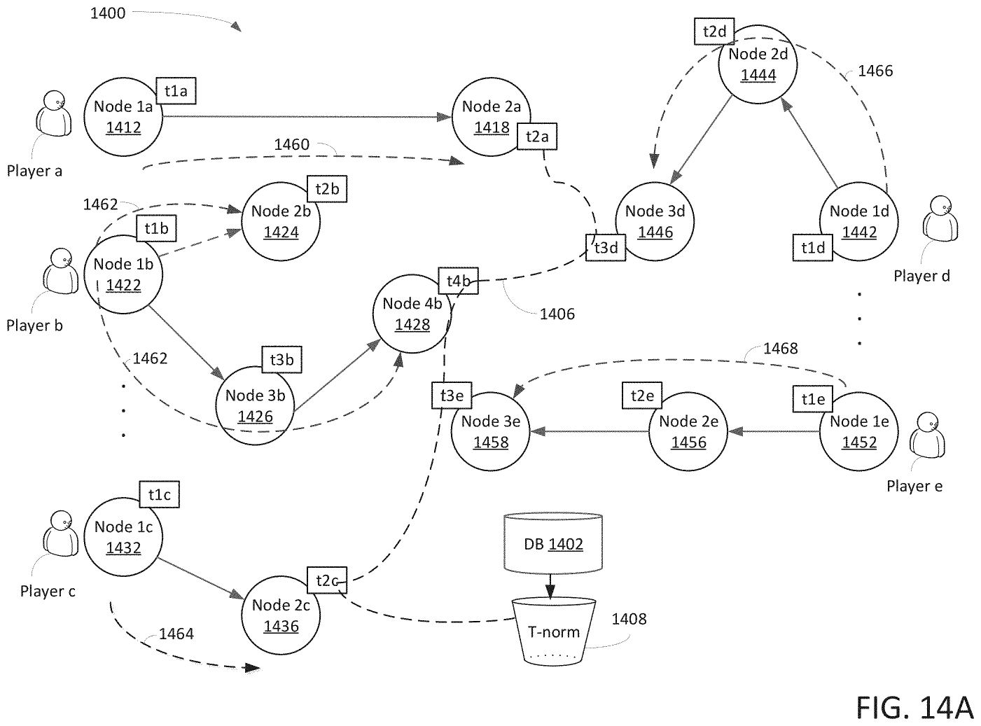

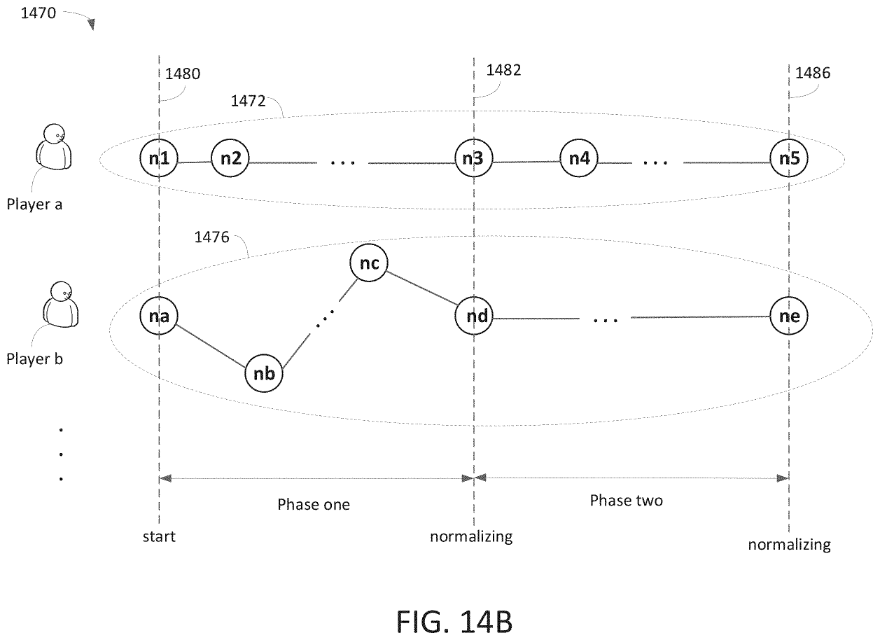

FIG. 14 is a block diagram 1400 illustrating a process of timeline normalization simulated by RCS system for emulating one or more rails in a war theater in accordance with one or more embodiments of the present invention. Diagram 1400 includes five players a-e, five rails 1460-1468, DB 1402, and timeline normalizer 1408. Each rail such as rail 1462 further includes a set of nodes to represent potential conflicting events or battle grounds. It should be noted that the underlying concept of the exemplary embodiment(s) of the present invention would not change if one or more blocks (players or nodes) were added to or removed from diagram 1400.

Player a travels on rail 1460 which contains node1a 1412 and node2a 1418 wherein node2a 1418 is where a process of timeline normalization is performed. In one aspect, node1a 1412 and node2a 1418 have time stamps t1a and t2a, respectively. Time stamp such as t1a or t2a records a time indicating time length taken to travel from one node to the next. For example, when player a begins to travel from node1a 1412 to node2a 1418, t2a minus t1a would indicate the time taken to travel from node1a 1412 to node2a 1418. It should be noted that time taken to move from one node to the next depending on multiple factors and/or parameters, such as, but not limited to, time needed to perform Monte Carlo algorithm calculations to estimate battle result(s), variables assigned to the player, nature of the battle, distance between the nodes, and so on.

Player b travels on rail 1462 containing node1b 1422, node2b 1424, node3b 1426, and node4b 1428 wherein node4b 1428 is the node in which a process of timeline normalization is performed. In one example, player b elects to travel from node1b 1422 to node3b 1426 and from node3b 1426 to node4b 1428 on rail 1462. In one aspect, nodes 1422-1428 contain time stamps t1b-t4b, respectively. When player b travels from node1b 1422 to node4b 1428, the time calculation, t4b minus t1b, would indicate the time taken to travel from node1b 1422 to node4b 1428.

Player c travels on rail 1464 which includes node1c 1432 with time stamp t1c and node2c 1436 with time stamp t2c. Player d travels on rail 1466 containing node1d 1442 with time stamp t1d and node3d 1446 with time stamp t3d. Play e proceeds on rail 1468 traveling from node1e 1452 to node3e 1458 via node2e 1456. In one aspect, all players begin their games generally at the same or similar time. For example, at the start of the game for players a-e, t1a, t1b, t1c, t1d, t1e are set to be the same time. Due to different rails containing different number of nodes, the time required to pass or move through the nodes can be different. Since each player travels through its rail independent from the other players, it creates arrival time discrepancies between the players. To synchronize timeline for subsequently events or continuation of the game, a timeline normalization is performed.

Timeline normalizer 1408, in one embodiment, is used to normalize timeline or time stamps associated to various rails based on timeline synchronization data retrieved from DB 1402. For example, the timeline synchronization data indicates every rail to be normalized at one (1) AM every morning. Alternatively, the timeline synchronization data can indicate that each rail should be normalized at a time with the least activities on the rails. In operation, at 1 AM each morning, timeline normalizer 1408, for example, provides a normalized time stamp to force t2a, t3d, t4b, t3e, and t2c to be the same as indicated by numeral 1406.

To normalize a timeline, the RCS system or game monitors, adjusts, and/or travels along predetermined rails with multiple events. It should be noted that traveling along multiverse stories, the player(s) encounters places where battle results are calculated by the MC algorithm (or any other algorithm as chosen by the system designer). The time length for each battle (as calculated by the algorithm) may vary based on the input variables, rails, nodes, and resources (bag of variables).

While the calculation of battle results may be hidden from the player(s), the screen may specify a duration of battle in the game play time with a ratio of one (1) hour of historical time to one (1) minute of game time. Because the length of battle time can vary in the game instance, the timeline of each event on the rail becomes discrete or de-synchronized in respect to other rails. It should be noted that the timeline relating to each multiverse story can be independent from other timeline associated to other rails. It should be further noted that time value or stamp at each place (node) in the event tree can be different depending on which tree branch one follows to arrive at a given node.

To continue the game proceeding to the next phase or stage, the process of normalizing timeline is required to synchronize time stamps at various rails during a predefined time frame or real-time period. For example, a normalization of timeline can be carried out to every rail once every midnight (the game time). For instance, at a predetermined time such as midnight, all time clocks in every branch timeline is realigned to an arbitrarily time stamp so that all rails are synchronized. Once the game time is synchronized, the subsequent steps or stages of the video game can be facilitated. In effect, the time normalization allows to forget where from the player arrived into a given node. Since each rail of the story has its own timeline, then the time at the arrival node, would depend on which alternative rail the player has arrived. The time normalization cancels any such time differences and recalibrates time at the arrival node to be the same, regardless how the player had gotten in there.

FIG. 14B is a block diagram 1470 illustrating an exemplary battle field scenario with phases or stages of timeline in accordance with one or more embodiments of the present invention. Diagram 1470 includes player a, player b, rails 1472-1476, and timeline with two phases or stages. In one example, player a travels along rail 1472 proceeding from node_1 (“n1”) through node_5 (“n5”) and player b walks through rail 1476 progressing from node_a (“na”) to node_e (“ne”). It should be noted that the underlying concept of the exemplary embodiment(s) of the present invention would not change if one or more blocks (players or nodes) were added to or removed from diagram 1470.

In one embodiment, diagram 1470 illustrates a battle field of Yom Kippur War which began on Oct. 6, 1973 and concluded on Oct. 25, 1973. To simulate the Yom Kippur War, a properly or aligned starting point of each day between Oct. 6 to Oct. 25, 1973 can be important. The timeline illustrated in diagram 1470 shows a starting time 1480, phase one 1482, and phase two 1486. For example, phase one illustrates the duration of day one (Oct. 6, 1973) and phase two is the duration of day two (Oct. 7, 1973). It should be noted that additional days can be similarly illustrated.

In operation, on Oct. 6, 1973, player a and player b start to proceed on rails 1472-1476 respectively, on starting line 1480. Upon various conflicts or battles represented by n1-n3 and na-nd at the end of day, the timeline 1482 is normalized so that all rails including rails 1472-1476 can start at the same time for the operations of day two or Oct. 7, 1973. At the end of two, the timeline 1486 is normalized again to prepare for the next day such as Oct. 8, 1973. As indicated earlier, each player can arrive at the end of each day at a different time based on many facts or parameters such as, but not limited to, the MC calculations, different branches, bag of variables, and the like.

An advantage of normalizing the timeline at various time points to synchronize the time stamps for facilitating the progress of the game.

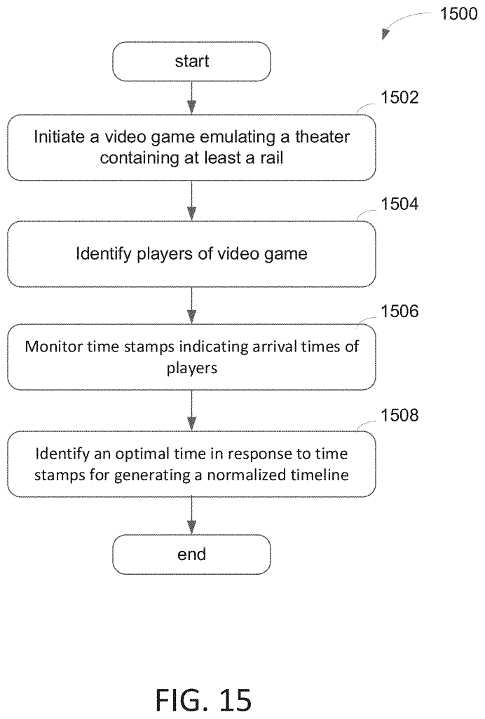

FIG. 15 is a flowchart 1500 illustrating an exemplary process of timeline normalization simulated by the RCS system capable of emulating a player's progress or movement between nodes on rails in accordance with one embodiment of the present invention. At block 1502, a process of normalizing timeline within the multiverse events is capable of initiating a video game emulating a war theater containing at least a first rail having multiple alternative nodes in accordance with at least a portion of recorded historical facts.

At block 1504, various players of the video game including at least one first player traveling between the conflicting nodes on the first rail approaching to a first timeline destination node within the theater are identified in accordance with values of variables associated with the player. In one example, the computer can be a player or players.

At block 1506, the time stamps associated with the rail indicating arrival times of the players are monitored. In one aspect, the time lengths for various battle results calculated by the MC algorithm (or other algorithm) are identified in response to input values.

At block 1508, the process is able to identify an optimal time in response to the time stamps for generating a normalized timeline for all players. For example, a list of predetermined time frames for synchronizing players' timeline in order to emulate next phase of video game can be retrieved from a storage location. Alternatively, an idle time frame indicating minimal or zero activities carried out by the players or by the computer can be identified. In one embodiment, after normalizing timeline, the video game with the normalized timeline for the players is resumed.

Status Report Based on Time Slice

One embodiment of the game system includes a function of status report using time stamped story slice status. For example, in order to post-fact or after a game, the system is able to visit the state of the game in the past and examine and/or edit its performance. A concept of “time slice” can be defined. At arbitrarily, dynamically as needed, predetermined times (time stamped for identification), the system takes a snapshot of all the unit positions on the map and all the variable values in the game at the slice's specific moment in time. Such time slice information is stored in the time slice data base. This way, at any time during development, testing or game maintenance, the system administrator or game designer can go back and recreate past status of the game at the given moment in time as defined by the slice. One can think of MAGS “time slice” as a snapshot of the game status at a given time.

Geographic Normalization

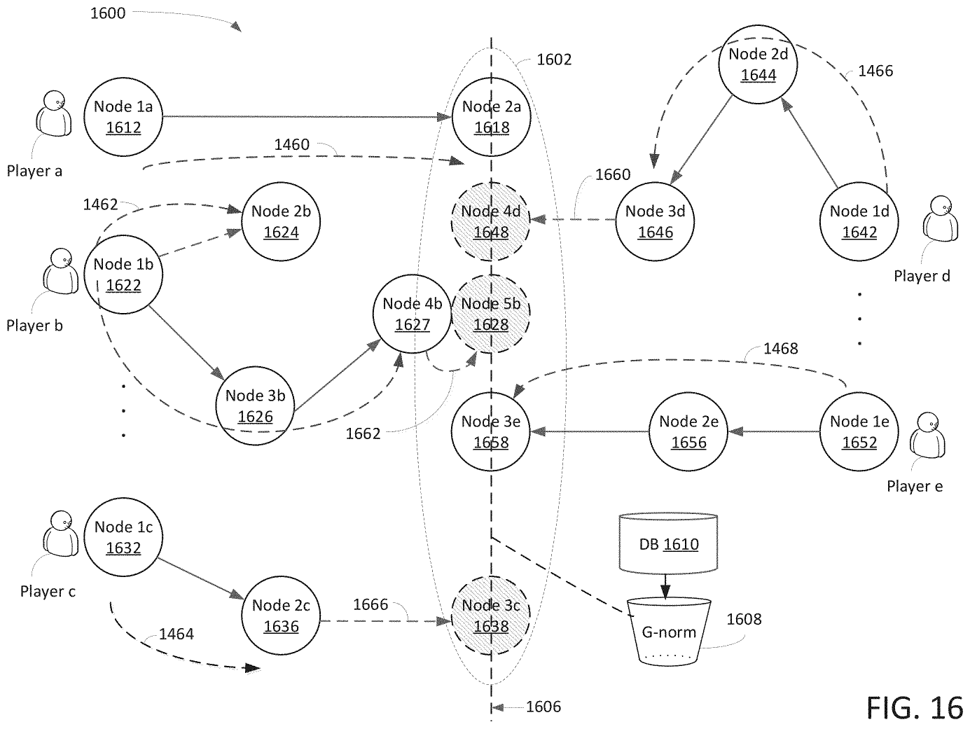

FIG. 16 is a block diagram 1600 illustrating a process of geographic normalization simulated by RCS for emulating one or more rails in a theater in accordance with one or more embodiments of the present invention. Diagram 1600 includes five players a-e, five rails 1460-1468, DB 1610, and geographic normalizer 1608. DB 1610 includes data or information relating to where or which location(s) should be used as frontline for normalization. Each rail such as rail 1462 further includes various nodes such as node1b-5b 1622-1628 representing potential conflicting events or battle grounds. It should be noted that the underlying concept of the exemplary embodiment(s) of the present invention would not change if one or more blocks (players or nodes) were added to or removed from diagram 1600.

Diagram 1600, in one embodiment, illustrates a process of normalizing geographic locations between a set of predefined locations facilitated by the RCS system. To properly progress a video game emulating a historical war theater, a process of normalizing various geographic locations as frontlines of a war or battle is required. As a result of a military campaign, for example, the subsequent geographic frontline should fall on one of the predefined locations in order to facilitating continuation of the game. For example, if a given river is a predefined frontline or location which can be a hundred square kilometers battle field(s) or mountain range, the RCS system guides or facilitates the game system to end a campaign along the natural geographic frontline such as a river, a mountain range, or some other terrain formation including the location of cities, highways, country borders, province borders or other man made features, before entering the next stage or phase.

During an operation, when the player proceeds on rail 1460 and arrives at node 2a 1618 at the frontline as indicated by frontline indictor 1606, no geographic normalization is required since it is right on the frontline. Player b, on the other hand, travels from node1b 1622 to node 4b 1627 along rail 1462. Upon arrival at node 4b 1627, geographic normalizer 1608 detects that player b stops at node 4b 1627 which is not at the frontline as indicated by frontline indictor 1606. Geographic normalizer 1608, in one embodiment, retrieves stored data from DB 1610 and normalizes or synchronizes the geographic discrepancy by moving node 4b 1627 to node 5b 1628 as indicated by numeral 1662. Similarly, when player c arrives at node 2c 1636 which is a distance away from the frontline, a new node 3c 1638 is added to the frontline as an extension of node 2c 1636 as indicated by numeral 1666. While player e arrives at node 3e 1658 right at the frontline, player d stops at node 3d 1646 which is not at the frontline. Geographic normalizer 1608 synchronizes the geographic locations at the frontline by extending node 3d 1646 to node 4d 1648 as indicated by numeral 1660.

An advantage of providing a geographic normalization is that it allows the players to end their campaigns or battles at any location which will be subsequently adjusted or synchronized for the next phase of the campaigns and/or battles. Another advantage is for the game designer/producer that the number of possible options on the map is finite and thus to allow to handle all the possible finite game options. The number of these finite frontline locations is a function of the complexity of the game and is subject to the designer considerations. In a less complex game story, there can be more possible normalizing frontline locations. In a very complex game, the number of frontlines will be less as to give the designer a realistic chance to complete the design.

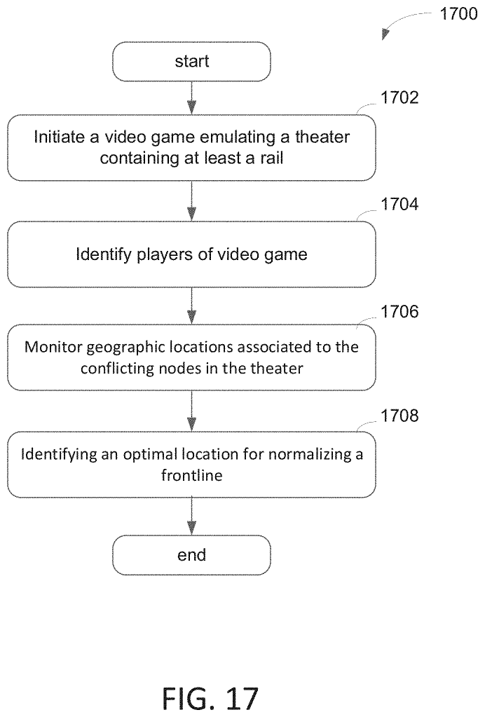

FIG. 17 is a flowchart 1700 illustrating an exemplary process of game designer geographic normalization simulated by RCS capable of emulating players' progress or movement between nodes on rails in accordance with one embodiment of the present invention. At block 1702, a process of geographic normalization initiates a video game emulating a war/story theater containing at least a first rail having multiple conflicting nodes in accordance with at least a portion of recorded historical facts.

At block 1704, the players of the video game including at least one player traveling between the conflicting nodes on the rail(s) approaching to a geographic destination node or frontline within the theater is identified in accordance with values of variables associated with the players;

At block 1706, the geographic locations associated to the conflicting nodes in the theater indicating movements of the players are monitored as the players gradually moving toward to the geographic destination node or frontline. It should be noted that each player may elect different sub-rails or branch-rails on the rail to reach his or her destination whereby the different locations can be resulted due to battle field calculation performed by the MC algorithm in response to various input values.

At block 1708, the process, in one embodiment, is capable of identifying an optimal location in response to detected geographic locations for normalizing a frontline for all players based on geographic data, destination node, and/or current locations. It should be noted that the computer itself can be one or multiple players for the game. In one example, upon retrieving a list of predetermined destination nodes for synchronizing players' physical locations along their rails for emulating next phase of video game, all players begin the next phase of video game at one of the pre-defined geographic frontline locations. Upon normalizing various geographic locations to generate a normalized frontline based on data, destination node, and the geographic locations, the video game resumes at the specific frontline for the players.

System

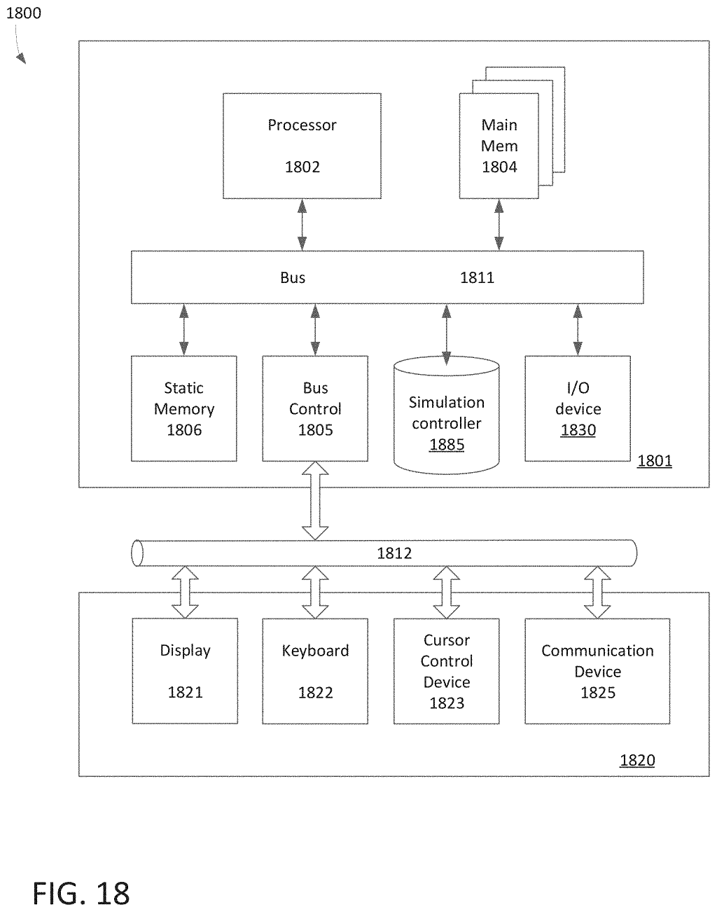

FIG. 18 is a block diagram 1800 illustrating a digital processing system capable of being configured to be the RCS system, database builder, and/or simulation allocator in accordance with one or more embodiments of the present invention. Computer system 1800 can include a processing unit 1801, an interface bus 1812, and an input/output (“IO”) unit 1820. Processing unit 1801 includes a processor 1802, main memory 1804, system bus 1811, static memory device 1806, bus control unit 1805, I/O element 1830, and simulation controller 1885. It should be noted that the underlying concept of the exemplary embodiment(s) of the present invention would not change if one or more blocks (circuit or elements) were added to or removed from FIG. 18.

Bus 1811 is used to transmit information between various components and processor 1802 for data processing. Processor 1802 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1804, which may include multiple levels of cache memories, stores frequently used data and instructions. Main memory 1804 may be RAM (random access memory), MRAM (magnetic RAM), or flash memory. Static memory 1806 may be a ROM (read-only memory), which is coupled to bus 1811, for storing static information and/or instructions. Bus control unit 1805 is coupled to buses 1811-1812 and controls which component, such as main memory 1804 or processor 1802, can use the bus. Bus control unit 1805 manages the communications between bus 1811 and bus 1812. Mass storage memory or SSD which may be a magnetic disk, an optical disk, hard disk drive, floppy disk, CD-ROM, and/or flash memories are used for storing large amounts of data.

I/O unit 1820, in one embodiment, includes a display 1821, keyboard 1822, cursor control device 1823, and communication device 1825. Display device 1821 may be a liquid crystal device, cathode ray tube (“CRT”), touch-screen display, or other suitable display device. Display 1821 projects or displays images of a graphical planning board. Keyboard 1822 may be a conventional alphanumeric input device for communicating information between computer system 1800 and computer operator(s). Another type of user input device is cursor control device 1823, such as a conventional mouse, touch mouse, trackball, or other type of cursor for communicating information between system 1800 and user(s).

Communication device 1825 is coupled to bus 1811 for accessing information from remote computers or servers, such as server or other computers, through wide-area network. Communication device 1825 may include a modem or a network interface device, or other similar devices that facilitate communication between computer 1800 and the network. Computer system 1800 may be coupled to a number of servers via a network infrastructure.

Simulation controller 1885, in one aspect, is used to provide RCS supporting emulating electronic video games. Simulation controller 1885 can be hardware, software, or a combination of hardware and software for facilitating building database and rails. In one embodiment, simulator controller 1885 facilitates game played by multiple players and ranks players based on their scores.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method for facilitating a film mode showing a sequence of events emulating a series of combat events via a resource confined simulation (“RCS”) system based on at least a portion of historical events, the method comprising:
simulating a first rail containing multiple conflicting nodes emulating a first theater in accordance with at least a portion of recorded historical facts facilitated by the RCS system;
facilitating a first user to travel on the first rail approaching to a first node of the conflicting nodes;
receiving an inquiry of film mode requesting a first film illustrating an accurate historical battle events based on the conflicting nodes on the first rail;
retrieving film data representing the historical battle events corresponding to various conflicting nodes on the first rail; and
playing a first film showing the historical battle events corresponding to at least some of the conflict nodes on the first rail via replacing player inputs with automatic inputs in response to the film data.

2. The method of claim 1, wherein retrieving first film data further includes initiating a process of adjusting existing input data at some of the conflict nodes entered earlier by the first user in accordance with the film data for facilitating the film mode.

3. The method of claim 1, further comprising emulating a video game facilitated by the RCS environment simulating battle fields along the first rail based on at least a portion of historical facts.

4. The method of claim 1, wherein simulating a first rail includes identifying one or more rail splitters along the first rail coupling to a new rail.

5. The method of claim 1, wherein facilitating a first user to travel on the first rail includes identifying a location along the first rail in which the first user is currently on.

6. The method of claim 1, wherein playing a first film includes automatically traveling from one conflict node to another along the first rail in accordance with the historical facts directed by the film data.

7. The method of claim 6, wherein playing a first film includes retrieving a plurality of clip videos associated with at least some of the conflict nodes on the first rail illustrating historical explanations of battles occurred at some of the conflict nodes.

8. The method of claim 7, wherein playing a first film includes introducing a game subject relating to a historical war based on recorded history indicated by the film data.

9. The method of claim 1, further comprising restoring status of the first rail and the location of the first user on the first rail after the first film is completed.

10. The method of claim 1, wherein playing a first film includes retrieving a stored video depicting actual history of battle associated to the first rail and playing the stored video to explain historical events occurred at the conflict nodes along the first rail.

11. A method for providing timeline normalization in multiverse events during a video game via a resource confined simulation (“RCS”) system, the method comprising:
initiating a video game emulating a theater containing at least a first rail having multiple conflicting nodes in accordance with at least a portion of recorded historical facts facilitated by the RCS system;
identifying players of the video game including at least one first player traveling between the conflicting nodes on the first rail approaching to a first timeline destination node within the theater in accordance with values of variables associated with the player;
monitoring time stamps indicating arrival times of the players to the first timeline destination node; and
identifying an optimal time in response to the time stamps for generating a normalized timeline for all players.

12. The method of claim 11, further comprising normalizing timeline to produce a first normalized timeline based on the time stamps.

13. The method of claim 11, wherein identifying players of the video game includes identifying computer as a second player.

14. The method of claim 11, wherein monitoring time stamps includes identifying time lengths for various battles calculated by the Monte Carlo algorithm in response to input values.

15. The method of claim 11, wherein identifying an optimal time includes retrieving a list of predetermined time frames for synchronizing players' timeline in order to emulate next phase of video game.

16. The method of claim 11, wherein identifying an optimal time includes identifying a down time indicating least activities carried out by the players.

17. The method of claim 11, further comprising resuming the video game with the normalized timeline for the players.

18. The method of claim 17, further comprising monitoring second time stamps indicating second arrival times of the players to a second timeline destination node in the theater.

19. The method of claim 18, further comprising identifying a second optimal time in response to the second time stamps for generating a second normalized timeline for all players.

20. A method for providing geographic normalization in multiverse events during a video game via a resource confined simulation (“RCS”) system, the method comprising:
initiating a video game emulating a theater containing at least a first rail having multiple conflicting nodes in accordance with at least a portion of recorded historical facts facilitated by the RCS system;
identifying players of the video game including at least one first player traveling between the conflicting nodes on the first rail approaching to a first geographic destination node within the theater in accordance with values of variables associated with the players;
monitoring geographic locations associated to the conflicting nodes in the theater indicating movements of the players in the geographic locations as the players gradually moving toward to a first geographic destination node; and
identifying an optimal location in response to detected geographic locations for normalizing a frontline for all players based on the first geographic destination node and the geographic locations.

21. The method of claim 20, further comprising normalizing various geographic locations to generate a first normalized frontline based on the first geographic destination node and the geographic locations.

22. The method of claim 20, wherein identifying players of the video game includes identifying computer as a second player.

23. The method of claim 20, wherein monitoring geographic locations includes identifying battle fields and battle results calculated by the Monte Carlo algorithm in response to input values.

24. The method of claim 20, wherein identifying an optimal location includes retrieving a list of predetermined destination nodes for synchronizing players' physical locations along rails for emulating next phase of video game.

25. The method of claim 24, wherein emulating next phase of video game includes facilitating all players to begin the next phase of video game at same or similar geographic frontline.

26. The method of claim 20, further comprising resuming the video game at the frontline for the players.

27. The method of claim 26, further comprising monitoring second geographic locations associated to second sets of conflicting nodes in the theater indicating movements of the players in the second geographic locations as the players gradually moving toward to a second geographic destination node.

28. The method of claim 27, further comprising identifying a second frontline in response to detected second geographic locations for providing a second frontline for all players based on the second geographic locations.

29. An apparatus for facilitating a film mode showing a sequence of events emulating a series of combat events via a resource confined simulation (“RCS”) system based on at least a portion of historical events, the apparatus comprising:
means for simulating a first rail containing multiple conflicting nodes emulating a first theater in accordance with at least a portion of recorded historical facts by the RCS system;
means for facilitating a first user to travel on the first rail approaching to a first node of the conflicting nodes;
means for receiving an inquiry of film mode initiated requesting a first film illustrating an accurate historical battles based on the conflicting nodes on the first rail;
means for retrieving film data representing the historical battle events corresponding to various conflicting nodes on the first rail; and
means for playing a first film showing the historical battle events corresponding to at least some of the conflict nodes on the first rail via replacing player inputs with automatic inputs in response to the film data.

30. The apparatus of claim 29, wherein means for retrieving first film data further includes means for initiating a process of adjusting existing input data at some of the conflict nodes entered earlier by the first user in accordance with the film data for facilitating the film mode.
